(19) United States
(12) Patent Application Publication
(10) Pub. No.: US 2014/0294009 A1
(43) Pub. Date: Oct. 2, 2014

(54) COMMUNICATION APPARATUS, COMMUNICATION SYSTEM, CONTROL METHOD OF COMMUNICATION APPARATUS AND PROGRAM

(71) Applicant: Sony Corporation, Tokyo (JP)

(72) Inventors: Yasunori Sahara, Kanagawa (JP); Kensuke Hatsukawa, Kanagawa (JP); Hiroshi Iwasaki, Kanagawa (JP); Takayuki Sugawara, Kanagawa (JP); Hideaki Yoshimura, Kanagawa (JP)

(73) Assignee: Sony Corporation, Tokyo (JP)

(21) Appl. No.: 14/205,468

(22) Filed: Mar. 12, 2014

(30) Foreign Application Priority Data
Mar. 29, 2013 (JP) 2013-072362

(51) Int. Cl. H04L 12/721; H04L 12/741

(52) U.S. Cl. CPC H04L 45/72; H04L 45/74
USPC 370/392

(57) ABSTRACT

There is provided a communication apparatus including a transmission source mapping algorithm acquisition unit configured to acquire an algorithm that assigns an external address and an external port number to an internal address and an internal port number of a transmission source, as a transmission source mapping algorithm, a destination mapping algorithm acquisition unit configured to acquire an algorithm that assigns an external address and an external port number to an internal address and an internal port number of a destination, as a destination mapping algorithm, and a generation unit configured to generate an external port number newly assigned to the internal address and the internal port number of the destination in a case where the transmission source mapping algorithm is more complicated than the destination mapping algorithm.

### CROSS REFERENCE TO RELATED APPLICATIONS

This application claims the benefit of Japanese Priority Patent Application JP 2013-072362 filed Mar. 29, 2013, the entire contents of which are incorporated herein by reference.

### BACKGROUND

The present disclosure relates to a communication apparatus, a communication system, a control method of the communication apparatus and a program. Specifically, it relates to communication apparatus that performs direct communication with other communication apparatus, a communication system, a control method of the communication apparatus and a program.

In the related art, an NAT (Network Address Translation) function is used to temporarily avoid a problem of IPv4 (Internet Protocol version 4) address depletion. The NAT function denotes a function to convert an IP (Internet Protocol) address into another IP address. Recently, NAPT (Network Address Port Translation) that can convert the port number in addition to the IP address, or an NAT function called “IP masquerade” is often used.

In the NAPT, for example, the external IP address and the external port number are assigned to the internal IP (Internet Protocol) address and the internal port number in a LAN (Local Area Network). Since NAT equipment such as a router can assign a plurality of external port numbers, it is possible to mutually convert a plurality of internal IP addresses and one external IP addresses by the NAPT. By this means, a plurality of devices in a LAN can use one external IP address and perform communication with an external device at the same time.

Here, in a case where the NAT equipment dynamically assigns the external port number to the devices in the LAN, the device outside the LAN has a difficulty in acquiring the external port number corresponding to the devices in the LAN. To solve this problem and cause the external device to access to a device under the control of the NAT equipment is called “NAT traversal”.

As a method to realize the NAT traversal, although there is a method where the user manually performs assignment of the external port number to the internal IP addresses (i.e., port mapping), since the user has to have special knowledge, it is difficult to be executed. Therefore, to automatically perform the port mapping, protocols such as UPnP (Universal Plug and Play) and STUN (Simple Traversal of UDP through NATs) are used. Among these, it is possible to perform only static port mapping in UPnP, moreover, it is not applicable unless NAT equipment and devices are adaptive to UPnP, and therefore it lacks versatility.

Meanwhile, in STUN, if the devices are adaptive to STUN, the NAT traversal can be performed without depending on the NAT equipment. In STUN, device S can investigate an algorithm of port mapping with respect to device D of the communication target. Moreover, in a communication system using this STUN, a technology called “hole punching” is often used. In the hole punching, for example, device D transmits a hole punching packet toward device S through NAT equipment on the device D side. By this hole punching packet, the port number that can be used for communication with device S is registered (in other words, released) in the NAT equipment on the device D side. However, if there is also NAT equipment on the device S side, this hole punching packet does not reach device S. This is because, at this time, the port number that can be used for communication with device D is not released in the NAT equipment on the device S side.

Since the hole punching packet does not reach device S, device S is not possible to acquire the port number released in the NAT equipment on the device D side. Therefore, device S predicts the released port number on the basis of the algorithm of port mapping investigated by STUN, and transmits a packet to the port number. By using these STUN and hole punching, devices in different LANs can perform direct communication with each other. By performing direction communication between the devices, the communication volume between a server and the devices and the load of the server are reduced.

To perform such direct communication, since devices S and D have to acquire the IP address and port number of the other party in advance, there is suggested a communication system in which the server notifies the IP address or the like to each of the devices (see JP 2005-45678A).

### SUMMARY

However, in the above-mentioned technology in the related art, there is fear that the direct communication fails. For example, when device D that generates a hole punching packet performs communication with another device S′, the external port number predicted by device S may be used in communication with that device S′. In this case, since the port number predicted by device S has a differ value from the port number actually released by hole punching, a packet transmitted by device S does not reach device D. As a result of this, direct communication fails.

The present disclosure is made taking into account such a condition, and it is desirable to improve the probability that direct communication between devices succeeds.

According to a first embodiment of the present technology, there is provided a communication apparatus, a control method thereof, and a program for causing a computer to execute the method, the communication apparatus including a transmission source mapping algorithm acquisition unit configured to acquire an algorithm that assigns an external address and an external port number to an internal address and an internal port number of a transmission source, as a transmission source mapping algorithm, a destination mapping algorithm acquisition unit configured to acquire an algorithm that assigns an external address and an external port number to an internal address and an internal port number of a destination, as a destination mapping algorithm, and a generation unit configured to generate an external port number newly assigned to the internal address and the internal port number of the destination in a case where the transmission source mapping algorithm is more complicated than the destination mapping algorithm. This causes an effect that a newly assigned external port number is generated in a case where the transmission source mapping algorithm is more complicated than the destination mapping algorithm.

According to the first embodiment of the present technology, the transmission source mapping algorithm acquisition unit may include a mapping investigation request packet transmission unit configured to transmit a plurality of packets that request a notification of the external address and the external port number assigned to the internal address and the internal port number of the transmission source, as mapping investigation request packets, to a plurality of different destinations, and a mapping investigation response packet reception unit configured to receive mapping investigation response packets with respect to the mapping investigation request packets and acquire the transmission source mapping algorithm based on the external address and the external port number notified by the mapping investigation response packets. This causes an effect that a transmission source mapping algorithm is acquired on the basis of the external address and the external port number notified by the mapping investigation response packet.

According to the first embodiment of the present technology, the communication apparatus may further include a transmission source filtering algorithm acquisition unit configured to acquire an algorithm that determines whether to cause a packet directed to the internal address and the internal port number of the transmission source to pass, as a transmission source filtering algorithm, and a destination filtering algorithm acquisition unit configured to acquire an algorithm that determines whether to cause a packet directed to the internal address and the internal port number of the destination to pass, as a destination filtering algorithm. The generation unit may generate the external port number in a case where the transmission source filtering algorithm is more complicated than the destination filtering algorithm or in a case where the transmission source filtering algorithm and the destination filtering algorithm are identical and the transmission source mapping algorithm is more complicated than the destination mapping algorithm. This causes an effect that the external port number is generated in a case where the transmission source filtering algorithm is more complicated than the destination filtering algorithm or in a case where the transmission source filtering algorithm and the destination filtering algorithm are identical and the transmission source mapping algorithm is more complicated than the destination mapping algorithm.

According to the first embodiment of the present technology, the communication apparatus may further include a table configured to store a flag that shows whether the transmission source mapping algorithm is more complicated than the destination mapping algorithm, for each combination of the transmission source mapping algorithm and the destination mapping algorithm, and an algorithm determination unit configured to determine whether the transmission source mapping algorithm is more complicated than the destination mapping algorithm, based on the flag corresponding to a combination of the transmission source mapping algorithm and the destination mapping algorithm. The generation unit may generate the external port number in a case where the algorithm determination unit determines that the transmission source mapping algorithm is more complicated than the destination mapping algorithm. This causes an effect that it is determined whether the transmission source mapping algorithm is more complicated than the destination mapping algorithm, on the basis of a flag stored in a table for each combination of the transmission source mapping algorithm and the destination mapping algorithm.

According to the first embodiment of the present technology, the communication apparatus may further include a same-intra-network address determination unit configured to determine whether the internal address of the transmission source and the internal address of the destination are addresses in a same local area network. The algorithm determination unit may determine whether the transmission source mapping algorithm is more complicated than the destination mapping algorithm, in a case where the internal address of the transmission source and the internal address of the destination are addresses in different local area networks. This causes an effect that it is determined whether the transmission source mapping algorithm is more complicated than the destination mapping algorithm, in a case where the internal address of the transmission source and the internal address of the destination are different addresses in different local area networks.

According to the first embodiment of the present technology, the communication apparatus may further include an address type determination unit configured to determine whether an assigned address is the internal address. The algorithm determination unit may determine whether the transmission source mapping algorithm is more complicated than the destination mapping algorithm, in a case where the assigned address is the internal address. This causes an effect that it is determined whether the transmission source mapping algorithm is more complicated than the destination mapping algorithm, in a case where the assigned address is the internal address.

According to the first embodiment of the present technology, the communication apparatus may further include a conversion device determination unit configured to determine whether a transmission source conversion device that executes the transmission source mapping algorithm and converts an internal address and an internal port number into an external address and an external port number, is identical with a determination conversion device that executes the destination mapping algorithm and converts an internal address and an internal port number into an external address and an external port number. The algorithm determination unit may determine whether the destination mapping algorithm is more complicated than the transmission source mapping algorithm, in a case where the transmission source conversion device and the destination conversion device are different. This causes an effect that it is determined whether the destination mapping algorithm is more complicated than the transmission source mapping algorithm, in a case where the transmission source conversion device and the destination conversion device are different.

According to the first embodiment of the present technology, the communication apparatus may further include a loop-back determination unit configured to determine whether the transmission source conversion device performs loop-back processing that forwards a packet from an external address assigned to the internal address of the transmission source to an external address corresponding to the internal address of the transmission source. The algorithm determination unit may determine whether the transmission source mapping algorithm is more complicated than the destination mapping algorithm, in a case where the transmission source conversion device and the destination conversion device are different or in a case where the transmission source conversion device and the destination conversion device are identical and the transmission source conversion device performs the loop-back processing. This causes an effect that it is determined whether the transmission source mapping algorithm is more complicated than the destination mapping algorithm, in a case where the transmission source conversion device and the destination conversion device are different or in a case where the transmission source conversion device and the destination conversion device are identical and the transmission source conversion device performs loop-back processing.

According to the first embodiment of the present technology, the communication apparatus may further include a hole punching packet transmission unit configured to transmit a packet to the external address and the external port number assigned to the internal address and the internal port number of the destination, as a hole punching packet, in a case where the transmission source mapping algorithm is not more complicated than the destination mapping algorithm. This causes an effect that the hole punching packet is transmitted to the external address and the external port number assigned to the internal address and the internal port number of the destination in a case where the transmission source mapping algorithm is not more complicated than the destination mapping algorithm.

According to the first embodiment of the present technology, the hole punching packet transmission unit may generate the external port number and transmits the hole punching packet to the external port number and the external address in a case where the transmission source mapping algorithm is a specific algorithm. This causes an effect that the hole punching packet is transmitted to the external address and the external port number generated in a case where the transmission source mapping algorithm is a specific algorithm.

According to the first embodiment of the present technology, the communication apparatus may further include a packet transmission unit configured to transmit a packet to a generated external port number when the external port number is generated. This causes an effect that a packet is transmitted to the external port number when the external port number is generated.

According to a second embodiment of the present technology, there is provided a communication system, including a server configured to transmit an algorithm that assigns an external address and an external port number to an internal address and an internal port number of a destination, as a destination mapping algorithm, and a communication apparatus including a transmission source mapping algorithm acquisition unit configured to acquire an algorithm that assigns an external address and an external port number to an internal address and an internal port number of a transmission source, as a transmission source mapping algorithm, a destination mapping algorithm reception unit configured to receive the destination mapping algorithm, and a generation unit configured to generate an external port number newly assigned to the internal address and the internal port number of the destination, in a case where the transmission source mapping algorithm is more complicated than the destination mapping algorithm. This causes an effect that a newly assigned external port number is generated in a case where the transmission source mapping algorithm is more complicated than the destination mapping algorithm.

According to the second embodiment of the present technology, the server may include a destination mapping algorithm transmission unit configured to transmit the destination mapping algorithm, a transmission source filtering algorithm transmission unit configured to acquire an algorithm that determines whether to cause a packet directed to the internal address and the internal port number of the transmission source to pass, and transmit the algorithm as a transmission source filtering algorithm, and a filtering algorithm transmission unit configured to acquire an algorithm that determines whether to cause a packet directed to the internal address and the internal port number of the destination to pass, and transmit the algorithm as a destination filtering algorithm. The communication apparatus may further include a transmission source filtering algorithm reception unit configured to receive the transmission source filtering algorithm, and a destination filtering algorithm reception unit configured to receive the destination filtering algorithm. The generation unit may generate the newly assigned external port number in a case where the transmission source filtering algorithm is more complicated than the destination filtering algorithm or in a case where the transmission source filtering algorithm and the destination filtering algorithm are identical and the transmission source mapping algorithm is more complicated than the destination mapping algorithm. This causes an effect that the external port number is generated in a case where the transmission source filtering algorithm is more complicated than the destination filtering algorithm or in a case where the transmission source filtering algorithm and the destination filtering algorithm are identical and the transmission source mapping algorithm is more complicated than the destination mapping algorithm.

According to the second embodiment of the present technology, the transmission source filtering algorithm transmission unit and the destination filtering algorithm transmission unit may include a filtering investigation request packet transmission unit configured to transmit a plurality of packets that request a reply to the external addresses and the external port numbers assigned to the internal addresses and internal port numbers of the transmission source and the destination, as filtering investigation request packets, from different external addresses and external port numbers in the server, and a filtering algorithm acquisition unit configured to acquire and transmit the transmission source filtering algorithm and the destination filtering algorithm, based on whether there is a reply to each of the filtering investigation request packets. This causes an effect that the transmission source filtering algorithm and the destination filtering algorithm are acquired on the basis of whether there is a reply to each of filtering investigation request packets.

According to an embodiment of the present disclosure, it is possible to provide an excellent advantage that it is possible to improve the probability that direct communication between devices succeeds.

### BRIEF DESCRIPTION OF THE DRAWINGS

FIG. 1 is a block diagram illustrating one configuration example of a communication system in a first embodiment;

FIG. 2 is a block diagram illustrating one configuration example of a router in the first embodiment;

FIG. 3 is a view illustrating one configuration example an address conversion table in the first embodiment;

FIG. 4 is a block diagram illustrating one configuration example of a device in the first embodiment;

FIG. 5 is a block diagram illustrating one configuration example of a server in the first embodiment;

FIG. 6 is a view illustrating one example of information stored in a device information storage unit 520 in the first embodiment;

FIG. 7 is a view illustrating one example of the data structure of a mapping investigation request packet in the first embodiment;

FIG. 8 is a view to describe a generation method of a mapping investigation response packet in the first embodiment;

FIG. 9 is a view illustrating one example of the data structure of a mapping investigation response packet at the time of endpoint-independent mapping in the first embodiment;

FIG. 10 is a view illustrating one example of the data structure of a mapping investigation response packet at the time of address-dependent mapping in the first embodiment;

FIG. 11 is a view illustrating one example of the data structure of mapping investigation response packet at the time of address-and-port-dependent mapping in the first embodiment;

FIG. 12 is a view illustrating one example of the data structure of a mapping investigation response packet at the time of random mapping in the first embodiment;

FIG. 13 is a view illustrating one example of the data structure of a mapping algorithm notification packet in the first embodiment;

FIG. 14 is a view illustrating one configuration example of a determination table in the first embodiment;

FIG. 15 is a flowchart illustrating one example of device operation in the first embodiment;

FIG. 16 is a flowchart illustrating one example of mapping algorithm acquisition processing in first embodiment;

FIG. 17 is a flowchart illustrating one example of NAT traversal processing in first embodiment;

FIG. 18 is a flowchart illustrating one example of server operation in the first embodiment;

FIG. 19 is a sequence diagram illustrating one example of server and device operation in the first embodiment;

FIG. 20 is a view illustrating one example of a usage condition of an external port number in the first embodiment;

FIG. 21 is a block diagram illustrating one configuration example of a router in a second embodiment;

FIG. 22 is a view illustrating one configuration example of a filtering table in the second embodiment;

FIG. 23 is a block diagram illustrating one configuration example of a server in the second embodiment;

FIG. 24 is a view illustrating one example of the data structure of a filtering investigation request packet in the second embodiment;

FIG. 25 is a view illustrating one example of a packet processed by endpoint-independent filtering and address-dependent filtering in the second embodiment;

FIG. 26 is a view illustrating one example of a packet processed by address-and-port-dependent filtering in the second embodiment;

FIG. 27 is a view illustrating one example of the data configuration of a filtering algorithm notification packet in the second embodiment;

FIG. 28 is a block diagram illustrating one configuration example of a device in the second embodiment;

FIG. 29 is a view illustrating one configuration example of a determination table in the second embodiment;

FIG. 30 is a flowchart illustrating one example of device operation in the second embodiment;

FIG. 31 is a flowchart illustrating one filtering algorithm acquisition processing in second embodiment;

FIG. 32 is a flowchart illustrating one example of server operation in the second embodiment;

FIG. 33 is a view illustrating one example of the usage condition of an external port number in the second embodiment;

FIG. 34 is a block diagram illustrating one configuration example of a device in a third embodiment;

FIG. 35 is a block diagram illustrating one configuration example of a network type determination unit in the third embodiment;

FIG. 36 is a view illustrating one example of device operation in the third embodiment;

FIG. 37 is a view illustrating one example of network types T1 and T2 in the third embodiment;

FIG. 38 is a view illustrating one example of network types T4 and T5 in the third embodiment;

FIG. 39 is a flowchart illustrating one example of device operation in the third embodiment; and

FIG. 40 is a flowchart illustrating one example of NAT traversal processing in the third embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In the following, a mode to implement the present disclosure (hereafter referred to as “embodiment”) is described. The explanation is given in the following order.

1. First Embodiment (example of determining master based on mapping algorithm)
2. Second Embodiment (example of determining master based on filtering algorithm and mapping algorithm)
3. Third Embodiment (example of determining master based on mapping algorithm after determining network type)

### 1. First Embodiment

### Configuration Example of Communication System

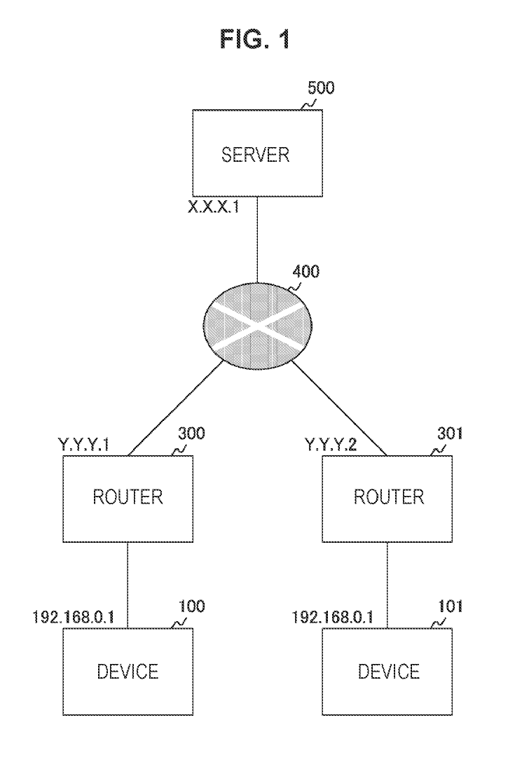

FIG. 1 is a block diagram illustrating one configuration example of a communication system in the first embodiment. This communication system denotes a system to perform direction communication between devices, and is used in an IP phone service, video conferencing system or online game, and so on. For example, the communication system includes devices 100 and 101 and a server 500.

The devices 100 and 101 are communication apparatuses in mutually different LANs. Private IP addresses are distributed to the devices 100 and 101 by a DHCP (Dynamic Host Configuration Protocol) server or the like in the LANs. The DHCP server is omitted in FIG. 1. Here, the device 100 or 101 may adopt a configuration including a global IP address. Moreover, a static private IP address may be set to the devices 100 and 101. Moreover, the devices 100 and 101 are one example of communication apparatuses described in the claims.

The device 100 is connected with a router 300 while the device 101 is connected with a router 301. This router 300 converts the IP address and port number of the device 100 into the global IP address and port number of the router 300. Meanwhile, the router 301 converts the IP address and port number of the device 101 into the global IP address and port number of the router 301.

Here, the IP address (private IP address or the like) and the port number before the conversion are referred to as “internal IP address” and “internal port number”. Also, the global IP address and the port number after the conversion are referred to as “external IP address” and “external port number”.

A device in the same LAN as the device 100 is optionally connected with this router 300 besides the device 100. Similarly, a device in same LAN as the device 101 is optionally connected with the router 301. Moreover, the devices 100 and 101 are connected with a WAN (Wide Area Network) 400 such as the Internet through the routers 300 and 301.

Also, although the router adopts a configuration to convert the IP address and the port number, other equipment than the router may adopt a configuration to convert the address and the port. For example, equipment in which an OS (Operation System) having a NAT function is installed may convert the IP address and the port number.

Also, a configuration is possible in which one or more routers are further installed between the routers 300 and 301 and the WAN 400, and they are connected to the WAN 400 via those routers.

The server 500 is equipment that manages the devices 100 and 101. When the devices 100 and 101 perform direct communication, the server 500 transmits information requested for the direct communication to the devices 100 and 101. Moreover, a plurality of global IP addresses are assigned to the server 500. A use method of these IP addresses is described later.

The device 100 and the device 101 are connected with the server 500, and, when the one transmits a session establishment request packet to request direction communication with the other to the server 500, the server 500 forwards the packet to the other.

Further, the device 100 acquires a mapping algorithm that assigns the external IP address and external port number of the router 300 to the internal IP address and internal port number of the device 100. On the other hand, the device 101 also acquires a mapping algorithm that assigns the external IP address and external port number of the router 301 to the internal IP address and internal port number of the device 101. The devices 100 and 101 notify the acquired mapping algorithms to each other through the server 500. Moreover, the devices 100 and 101 notify their external IP addresses and external port numbers to each other through the server 500.

The devices 100 and 101 determine which of them becomes a master, on the basis of the acquired mapping algorithms. Here, the master is a device that optionally predicts an external port number that is newly assigned (in other words, released) by a hole punching packet out of two devices that try to perform direct communication. On the other hand, the slave is a device that optionally transmits the hole punching packet and newly releases the external port number.

The slave optionally transmits a packet directed to the master as a hole punching packet. Further, the master optionally predicts the external port number that is newly assigned by the slave on the basis of an external port number of the slave and the slave, and transmits a communication packet to the predicted port number. By this means, the direct communication between the master and the slave is realized.

[Configuration Example of Router]

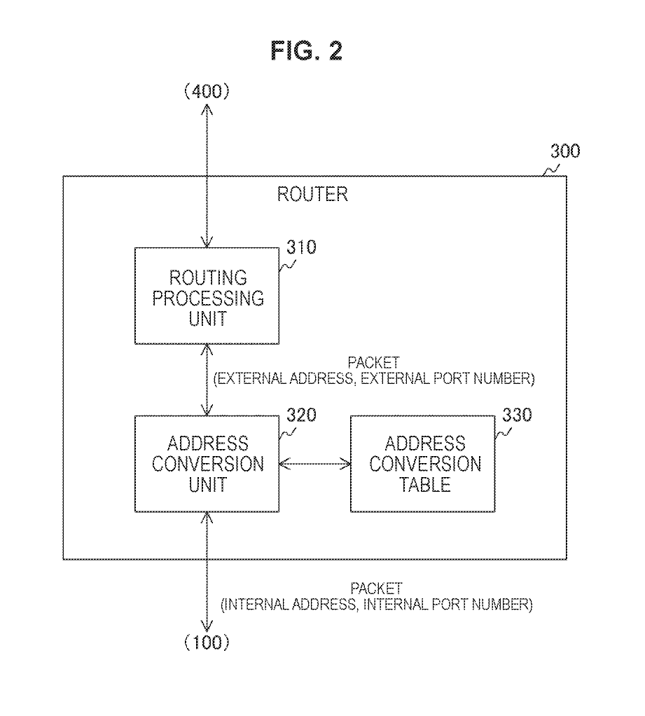

FIG. 2 is a block diagram illustrating one configuration example of the router 300 in the first embodiment. The router 300 includes a routing processing unit 310, an address conversion unit 320 and an address conversion table 330. The configuration of the router 301 is similar to the router 300.

When receiving the packet, the routing processing unit 310 selects a path of the packet (i.e., routing) on the basis of the destination of the received packet. This routing processing unit 310 forwards a packet from the inside of the LAN after address conversion to the outside and forwards a packet from the outside to the inside through the address conversion unit 320.

The address conversion unit 320 mutually converts the internal IP address, the internal port number, the external IP address and the external port number. When receiving the packet from the inside of the LAN to the outside, this address conversion unit 320 determines whether the external port number corresponding to the internal IP address and internal port number of the transmission source of the packet is registered in the address conversion table 330.

If the corresponding external port number is registered, the address conversion unit 320 converts the internal IP address and the internal port number into the external IP address of the router 300 and the external port number thereof and supplies them to the routing processing unit 310.

On the other hand, if the corresponding external port number is not registered, the address conversion unit 320 newly assigns an external port number to the internal IP address and the internal port number according to a preset mapping algorithm and registers it in the address conversion table 330. Further, the address conversion unit 320 converts the internal IP address and the internal port number into the external IP address of the router 300 and the assigned external port number, and supplies them to the routing processing unit 310.

Here, as the mapping algorithm, for example, an algorithm of any of endpoint-independent mapping, address-dependent mapping, address-and-port-dependent mapping and random mapping is used. Details of these algorithms are described later. Among these, the endpoint-independent mapping, the address-dependent mapping and the address-and-port-dependent mapping are defined as RFC (Request for Comments) 4787 or the like.

Moreover, the address conversion unit 320 receives the packet from the outside of the LAN to the inside, from the routing processing unit 310. The address conversion unit 320 determines whether the internal IP address and internal port number corresponding to the external port number of the destination of the packet are registered in the address conversion table 330.

If the corresponding internal IP address and internal port number are registered, the address conversion unit 320 converts the external IP address and the external port number into the internal IP address and the internal port number, and forwards them to the destination.

On the other hand, if the corresponding internal IP address and internal port number are not registered, the address conversion unit 320 discards the received packet.

[Configuration Example of Address Conversion Table]

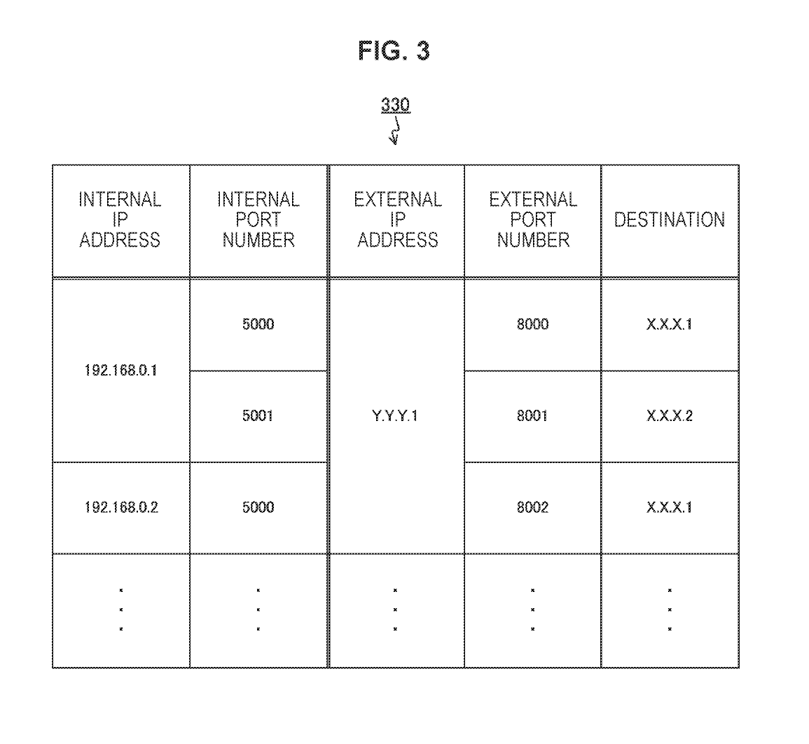

FIG. 3 is a view illustrating one configuration example of the address conversion table 330 in the first embodiment. In this address conversion table 330, the external IP address, the external port number and the destination are registered every internal IP address and internal port number.

The destination registered in the address conversion table 330 is the IP address and port number of the destination of a packet transmitted from the inside of the LAN to the outside, and is registered in association with the internal IP address and internal port number of the transmission source of the packet.

This destination is used to determine whether to newly assign an external port number in a mapping algorithm.

Specifically, the destination is not referred to in the endpoint-independent mapping. This is because, in the endpoint-independent mapping, when the external port number with respect to the internal IP address and the internal port number is registered once, an external port number is not newly assigned even if the destination changes.

For example, a case is assumed where there are a device with (internal IP address: internal port number) of (X1: x1), a device with (external IP address: external port number) of (Y1: y1) and a device with (external IP address: external port number) of (Y2: y2). The device of (X1:x1) is, for example, the device 101, and the device of (Y1: y1) is, for example, the server 500. The device of (Y2: y2) is, for example, the router 301. Moreover, the external IP address of a communication interface of the router 300 is X1′ and the external port number of the router 300 is x1′ or x2′, and so on.

In the endpoint-independent mapping, when a packet is transmitted from (X1: x1) to (Y1: y1) in initial state, (X1′: x1′) of the router 300 is assigned to (X1: x1). However, even if a packet is transmitted from (X1: x1) to (Y2: y2) afterwards, a new external port number is not assigned to (X1: x1) and the transmission source of the packet is converted into (X1′: x1′).

Next, in the address-dependent mapping, when the destination IP address changes, a new external port number is assigned.

In the address-dependent mapping, for example, when a packet is transmitted from (X1: x1) to (Y1: y1) in initial state, (X1′: x1′) and destination Y1 are registered in association with (X1: x1). Afterwards, when a packet is transmitted from (X1: x1) to (Y2: y2), since the destination IP addresses are different, (X1′: x2′) is newly assigned to (X1: x1) in association with destination Y2. Meanwhile, even if a packet is transmitted from (X1: x1) to (Y1: y2), since the destination IP addresses are identical, a new external port number is not assigned. The address conversion table 330 exemplified in FIG. 3 is a table used in this address-dependent mapping.

Further, in the address-and-port-dependent mapping, when the IP address or port number of the destination changes, a new external port number is assigned.

In the address-and-port-dependent mapping, for example, when a packet is transmitted from (X1: x1) to (Y1: y1) in initial state, (X1′: x1′) and destination (Y1: y1) are registered in association with (X1: x1). Afterwards, when a packet is transmitted from (X1: x1) to (Y2: y2), since the destination IP addresses are different, (X1′: x2′) is newly assigned to (X1: x1) in association with destination (Y2: y2). Moreover, even in a case where a packet is transmitted from (X1: x1) to (Y1: y2), since the destination port numbers are different, a new external port number is assigned.

In these endpoint-independent mapping, address-dependent mapping and address-and-port-dependent mapping, a regularly generated external port number is assigned. For example, in a case where certain external port number x1′ is assigned and a new external port number is assigned next, a number incrementing x1′ is assigned.

By contrast with this, in the random mapping, an irregularly generated external port number is assigned every time the IP address or port number of destination changes.

Thus, complexity is different in these mapping algorithms. The address-dependent mapping in which the external port number is assigned every time the destination changes is more complicated than the endpoint-independent mapping in which a new external port number is not assigned even if the destination changes. Moreover, the address-and-port-dependent mapping in which the external port number is assigned every time the destination port number changes is more complicated than the address-dependent mapping in which a new external port number is not assigned even if the destination port number changes. Moreover, the random mapping in which the port number is irregularly assigned is more complicated than the address-and-port-dependent mapping in which the port number is regularly assigned.

That is, when they are arranged in order of complexity degree, they are arranged in order from the random mapping, the address-and-port-dependent mapping, the address-dependent mapping to the endpoint-independent mapping.

As the algorithm becomes complicated, it becomes difficult to predict a newly assigned external port number. Therefore, it is desirable that the device 100 or 101 predicts the external port number assigned by a simpler algorithm. For example, a case is assumed where the mapping algorithm of the router 301 supporting the device 101 is more complicated than the mapping algorithm of the router 300 supporting the device 100. In this case, the device 101 may become a master and only has to predict the external port number on the basis of a prediction algorithm corresponding to the simpler mapping algorithm of the router 300.

[Configuration Example of Device]

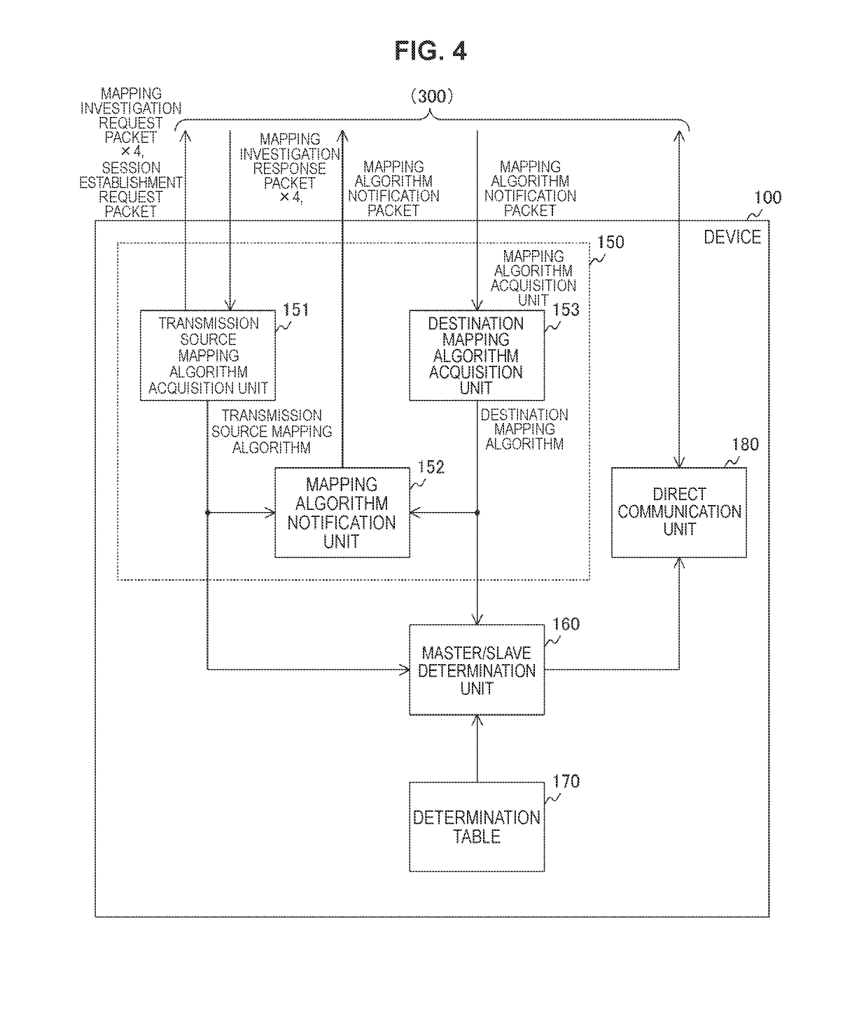

FIG. 4 is a block diagram illustrating one configuration example of the device 100 in the first embodiment. This device 100 includes a mapping algorithm acquisition unit 150, a master/slave determination unit 160, a determination table 170 and a direct communication unit 180. Moreover, the mapping algorithm acquisition unit 150 includes a transmission source mapping algorithm acquisition unit 151, a mapping algorithm notification unit 152 and a destination mapping algorithm acquisition unit 153. The configuration of the device 101 is similar to the device 100.

The transmission source mapping algorithm acquisition unit 151 acquires an algorithm that assigns the external port number to the internal IP address and internal port number of the transmission source device, as a transmission source mapping algorithm. When direct communication is requested, the transmission source mapping algorithm acquisition unit 151 transmits a session establishment request packet that designates the communication target device to the server 500. For example, this session establishment request packet is transmitted and received according to the SIP (Session Initiation Protocol).

After transmitting the session establishment request packet, the transmission source mapping algorithm 151 transmits a plurality of mapping investigation request packets to the server 500. These mapping investigation request packets denote packets that request notification of the external IP address and external port number assigned to the internal IP address and internal port number of the device 100. As described above, a mapping method when the destination changes varies every mapping algorithm. To determine the difference in this algorithm, a plurality of mapping investigation request packets are sequentially transmitted to respective destinations.

For example, four mapping investigation request packets Rqm1, Rqm2, Rqm3 and Rqm4 of different destinations are sequentially transmitted. Rqm2 denotes a packet that has the same destination IP address as Rqm1 and has a different destination port number from Rqm1. Rqm3 denotes a packet that has a different destination IP address from Rqm1 and has the same port number as Rqm1. Rqm4 denotes a packet that has a different destination IP address and port number from Rqm1. A plurality of external IP addresses are requested to receive these four packets by one server 500. Therefore, the plurality of external IP addresses are assigned to a communication interface of the server 500.

The router 300 assigns the external IP address and external port number to the internal IP address and internal port number of the transmission source of the mapping investigation request packets. The server 500 generates mapping investigation response packet Rpm1 storing the external IP address and external port number of the transmission source of mapping investigation request packet Rqm1 in a payload, and returns it to the device 100. Similarly, the server 500 generates mapping investigation response packets Rpm2, Rpm3 and Rpm4 according to mapping investigation request packets Rqm2, Rqm3 and Rqm4, and returns them to the device 100.

The transmission source mapping algorithm acquisition unit 151 receives those mapping investigation response packets and acquires the external IP addresses and the external port numbers from the payloads. Further, the transmission source mapping algorithm acquisition unit 151 acquires a transmission source mapping algorithm from those external IP addresses and external port numbers.

To be more specific, in a case where the external port numbers of four mapping investigation request packets are all identical, the transmission source mapping algorithm acquisition unit 151 determines the endpoint-independent mapping. This is because, even if the destination changes in this endpoint-independent mapping, the port number corresponding to a device in a LAN is not changed.

Moreover, a case is considered where the external port numbers of mapping investigation response packets Rpm1, Rpm3 and Rpm4 are different though the external port numbers of mapping investigation response packets Rpm1 and Rpm2 are the same. In this case, the transmission source mapping algorithm acquisition unit 151 determines the address-dependent mapping. This is because the port number corresponding to the device in the LAN is changed when the destination IP address changes in this address-dependent mapping.

Moreover, when the external port numbers of four mapping investigation request packets are all different, the transmission source mapping algorithm acquisition unit 151 calculates the difference between adjacent external port numbers in the transmission order of the mapping investigation request packets. Since four mapping investigation request packets are transmitted in order, three differences are calculated. In a case where those differences are the same, the transmission source mapping algorithm acquisition unit 151 determines the address-and-port-dependent mapping. This is because the port number corresponding to the device in the LAN is regularly changed when the IP address or port number of the destination changes in this address-and-port-dependent mapping.

In a case where the external port numbers of four mapping investigation request packets are all different and three calculated differences are not identical, the transmission source mapping algorithm acquisition unit 151 determines the random mapping. This is because the port number corresponding to the device in the LAN is irregularly changed when the IP address or port number of the destination changes in this random mapping.

The transmission source mapping algorithm acquisition unit 151 supplies the transmission source mapping algorithm, the external IP address and external port number of the device 100 and the calculated difference to the mapping algorithm notification unit 152. Moreover, the transmission source mapping algorithm acquisition unit 151 supplies the transmission source mapping algorithm to the master/slave determination unit 160.

The mapping algorithm notification unit 152 notifies the mapping algorithm acquired by the device 100 to the device 101 through the server 500. This mapping algorithm notification unit 152 generates a mapping algorithm notification packet that stores the mapping algorithm acquired by the device 100, the external IP address and external port number of the device 100 and the difference in a payload. The mapping algorithm notification unit 152 transmits the mapping algorithm notification packet to the server 500. The server 500 forwards the mapping algorithm notification packet to the device 101.

The destination mapping algorithm acquisition unit 153 acquires an algorithm that assigns the external port number to the internal IP address and internal port number of the destination device, as a destination mapping algorithm. This destination mapping algorithm acquisition unit 153 receives the mapping algorithm notification packet from the device 101, which was forwarded by the server 500. The destination mapping algorithm acquisition unit 153 acquires the destination mapping algorithm, the external IP address and external port number of the device 101 and the difference from the payload of the mapping algorithm notification packet. The destination mapping algorithm acquisition unit 153 supplies them to the master/slave determination unit 160.

Although FIG. 4 illustrates packets transmitted and received in a case where the device 100 is the transmission source of the session establishment request packet, packets transmitted and received in a case where the device 100 is the destination are omitted for convenience of description. In a case where the device 100 is the destination, the destination mapping algorithm acquisition unit 153 receives the session establishment request packet from the device 101. Further, the destination mapping algorithm acquisition unit 153 transmits four mapping investigation request packets to the server 500 and acquires a destination mapping algorithm from the response packets thereof. The mapping algorithm notification unit 152 transmits the destination mapping algorithm to the device 101 through the server 500. Meanwhile, the transmission source mapping algorithm acquisition unit 151 receives the mapping algorithm notification packet from the device 101 and acquires the transmission source mapping algorithm, the external IP address and external port number of the device 101 and the difference.

The determination table 170 stores a flag showing whether to set the device 100 as a master, for each combination of the transmission source mapping algorithm and the destination mapping algorithm. For example, in a case where the transmission source mapping algorithm is more complicated than the destination mapping algorithm, the transmission source device source becomes the master and predicts the external port number on the basis of the simpler destination mapping algorithm. By contrast, in a case where the destination mapping algorithm is more complicated than the transmission source mapping algorithm, the destination device becomes the master and predicts the external port number on the basis of the simpler transmission source mapping algorithm. In a case where the complexity of the destination mapping algorithm and the complexity of the transmission source mapping algorithm are identical, for example, the transmission source device is set as a master.

Here, in a case where the destination mapping algorithm and the transmission source mapping algorithm are identical, since the superiority or inferiority is not decided between the transmission source and destination devices, the destination device may be set as the master.

The master/slave determination unit 160 determines whether to set the device 100 as the master, on the basis of the transmission source mapping algorithm and the destination mapping algorithm. This master/slave determination unit 160 reads out a flag corresponding to the transmission source mapping algorithm and the destination mapping algorithm, from a determination table, and determines whether to set the device 100 as the master. The master/slave determination unit 160 supplies the determination result, the mapping algorithm of the device 101, the external IP address and external port number of the device 101 and the difference to the direct communication unit 180.

The direct communication unit 180 performs direct communication with the device 101. From the external port number and the difference, the direct communication unit 180 predicts a newly assigned external port number according to a prediction algorithm corresponding to the mapping algorithm on the slave (device 101) side.

To be more specific, in a case where the mapping algorithm on the slave side is the address-dependent mapping or the address-and-port-dependent mapping, the direct communication unit 180 generates the port number adding the difference to the received external port number, as a predicted external port number.

The direct communication unit 180 generates a communication packet directed to the external IP address of the device 101 and is the generated external port number, and transmits it not via the server 500. By this means, the direct communication with the device 101 is realized.

Here, a case is considered where the device 100 is the master and a mapping algorithm on the master (device 100) side is the endpoint-independent mapping. In this case, when the master transmits a communication packet to not only the predicted external port number but also the external port number in the periphery, the probability of succeeding in direct communication improves.

Meanwhile, a case is considered where the device 100 is the slave and a mapping algorithm on the master (device 101) side is other than the endpoint-independent mapping. In this case, the direct communication unit 180 transmits a packet directed to the external IP address of the device 101 and the generated port number, as a hole punching packet.

Here, it is desirable to adjust the TTL (Time To Live) of the hole punching packet so as not to reach the highest router.

Moreover, in a case where a mapping algorithm on the master side is other than the endpoint-independent mapping, the slave predicts an external port number released in the router on the master side and transmits the hole punching packet to the external port number. At this time, when the slave performs multi-hole punching, the probability of succeeding in direct communication improves. The multi-hole punching denotes that the slave transmits a plurality of hole punching packets. By the multi-hole punching, not only the external port number predicted by the master but also the external port number in the periphery is released. In the prediction of the external port number, there is a case where the actually released external port number differs from the predicted external port number. For example, devices other than the device 101 may be connected with the router 301 of the device 101 side, and, when the router 300 assigns the external port number to the device, a released external port number may be different from the prediction. Alternatively, when the router 300 assigns the external port number to the internal port number of other network services operating in the device 101, a released external port number may be different from the prediction. By the multi-hole punching, it is possible to support such a difference in the external port number, and the probability of succeeding in direct communication improves.

Moreover, in a case where the device 100 is the slave and a mapping algorithm on the slave side is the endpoint-independent mapping, the direct communication unit 180 does not have to transmit the hole punching packet. This is because the external port number corresponding to the slave is not changed even if the address changes in the endpoint-independent mapping.

When a new external port number is registered (released) by the hole punching packet, the master (device 101) predicts a released external port number and transmits a communication packet. The direct communication unit 180 receives the communication packet. By this means, direct communication with the device 100 is realized.

Here, the direct communication unit 180 is one example of a generation unit described in the claims.

[Configuration Example of Server]

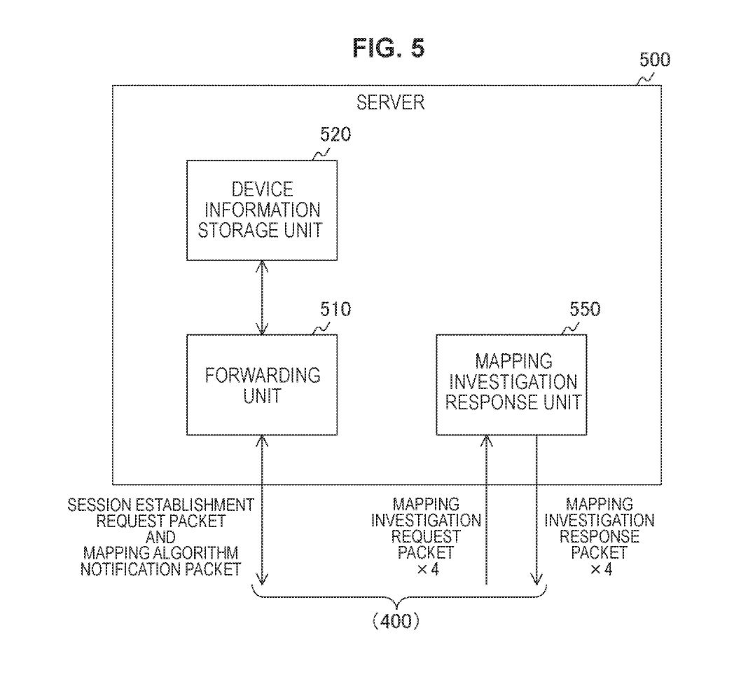

FIG. 5 is a block diagram illustrating one configuration example of the server 500 in the first embodiment. This server 500 includes a forwarding unit 510, the device information storage unit 520 and a mapping investigation response unit 550.

The device information storage unit 520 stores identification information of a device and the external IP address and external port number of the device in association with each other, every device connected with the server 500. The identification information of the device denotes identification information assigned to the device in a service that provides direct communication, such as the device name and the user name of the device.

The forwarding unit 510 forwards a session establishment request packet and a mapping algorithm notification packet. When starting communication with the server 500, the forwarding unit 510 causes the device information storage unit 520 to store the identification information of the device and the external IP address and external port number of the device in association with each other.

Further, when receiving the session establishment request packet from the device, the forwarding unit 510 reads out the external IP address and external port number of the device with which the session request packet requests connection, from the device information storage unit 520. Further, the forwarding unit 510 forwards the session establishment request packet to the read external IP address and external port number.

When receiving a mapping algorithm notification packet from one of the transmission source and destination of the session establishment request packet after the session establishment request packet is forwarded, the forwarding unit 510 forwards the packet to the other.

The mapping investigation response unit 550 returns a mapping investigation response packet according to the mapping investigation request packet. When receiving the mapping investigation request packet, this mapping investigation response unit 550 acquires the external IP address and external port number of the transmission source of the packet. The mapping investigation response unit 550 generates the mapping investigation response packet that stores the acquired external IP address and external port number in a payload, and returns it to the transmission source of the mapping investigation request packet.

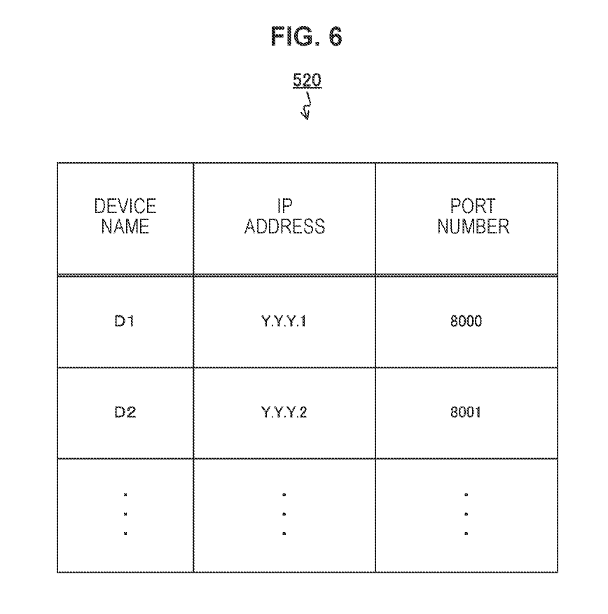

FIG. 6 is a view illustrating one example of information stored in the device information storage unit 520 in the first embodiment. The device information storage unit 520 stores the device name, the IP address and the port number in association with each other. These IP address and port number denote the external IP address and external port numbers assigned to the internal IP address and internal port number of the device.

For example, when device name “D1” is connected with the server 500, IP address “Y.Y.Y.1” and port number “8000 are associated with “D1” and stored. Moreover, when device name “D2” is connected with the server 500, IP address “Y.Y.Y.2” and port number “8001” are associated with “D1” and stored.

When the device of “D1” transmits a session establishment request packet that designates “D2” as a communication target to the server 500, the server 500 forwards the packet to “Y.Y.Y.2” and “8001” corresponding to “D2”.

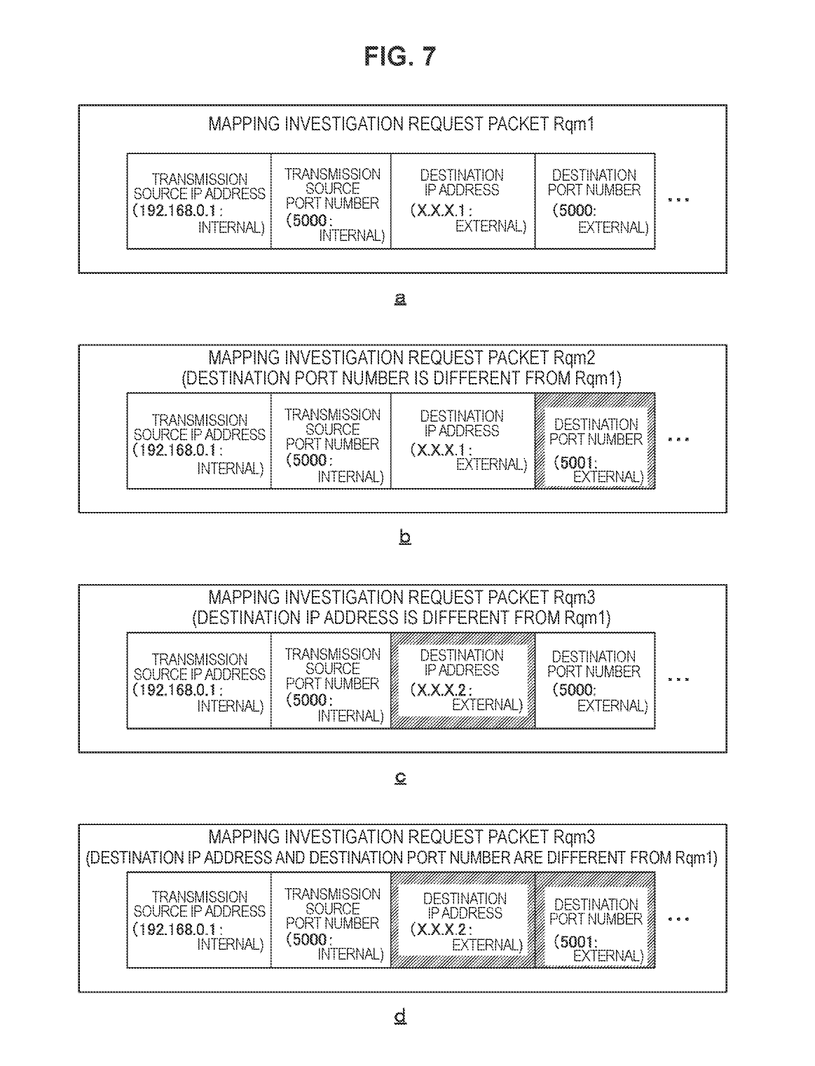

FIG. 7 is a view illustrating one example of the data structures of mapping investigation request packets in the first embodiment. In FIG. 7, “a” shows a view illustrating one example of the data structure of mapping investigation request packet Rqm1. This packet includes the transmission source IP address, the transmission source port number, the destination IP address and the address port number in the header. These transmission source IP address and transmission source port number demote the internal IP address and internal port number of the device 100. Moreover, the destination IP address and the address port number denote the external IP address and external port number of the server 500.

In FIG. 7, “b” shows a view illustrating one example of the data structure of mapping investigation request packet Rqm2. Mapping investigation request packet Rqm2 has a configuration similar to mapping investigation request packet Rqm1 except for that the address port number is different.

In FIG. 7, “c” shows a view illustrating one example of the data structure of mapping investigation request packet Rqm3. Mapping investigation request packet Rqm3 has a configuration similar to mapping investigation request packet Rqm1 except for that the destination IP address is different.

In FIG. 7, “d” shows a view illustrating one example of the data structure of mapping investigation request packet Rqm4. Mapping investigation request packet Rqm4 has a configuration similar to mapping investigation request packet Rqm1 except for that the destination IP addresses and the address port numbers are different.

The device 100 can acquire the mapping algorithm of the router 300 corresponding to the device 100 from the mapping investigation response packets with respect to these mapping investigation request packets.

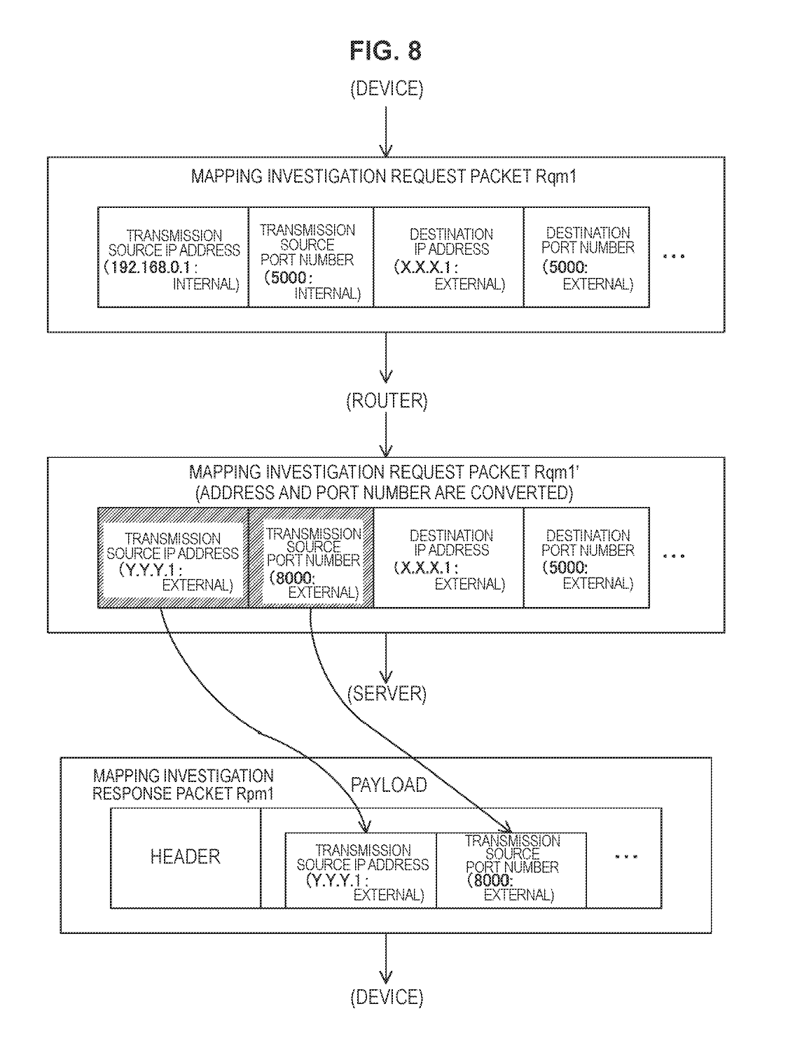

FIG. 8 is a view to describe a generation method of a mapping investigation response packet in the first embodiment. When mapping investigation request packet Rqm1 is transmitted from the device 100, the router 300 converts the internal IP address and internal port number of the transmission source of mapping investigation request packet Rqm1 into the external IP address and the external port number. Since it is not possible to directly refer to these external IP address and external port number from the device 100, they have to be notified from the server 500 by the mapping investigation response packet.

The server 500 acquires the IP address and port number of the transmission source of mapping investigation request packet Rqm1′ in which the IP address or the like is converted, from the header, and generates mapping investigation response packet Rpm1 that stores them in the payload. Further, the server 500 returns that mapping investigation response packet Rpm1 to the device 100. The device 100 can acquire the external IP address and external port number assigned to the device 100 by referring to the payload of that mapping investigation response packet Rpm1.

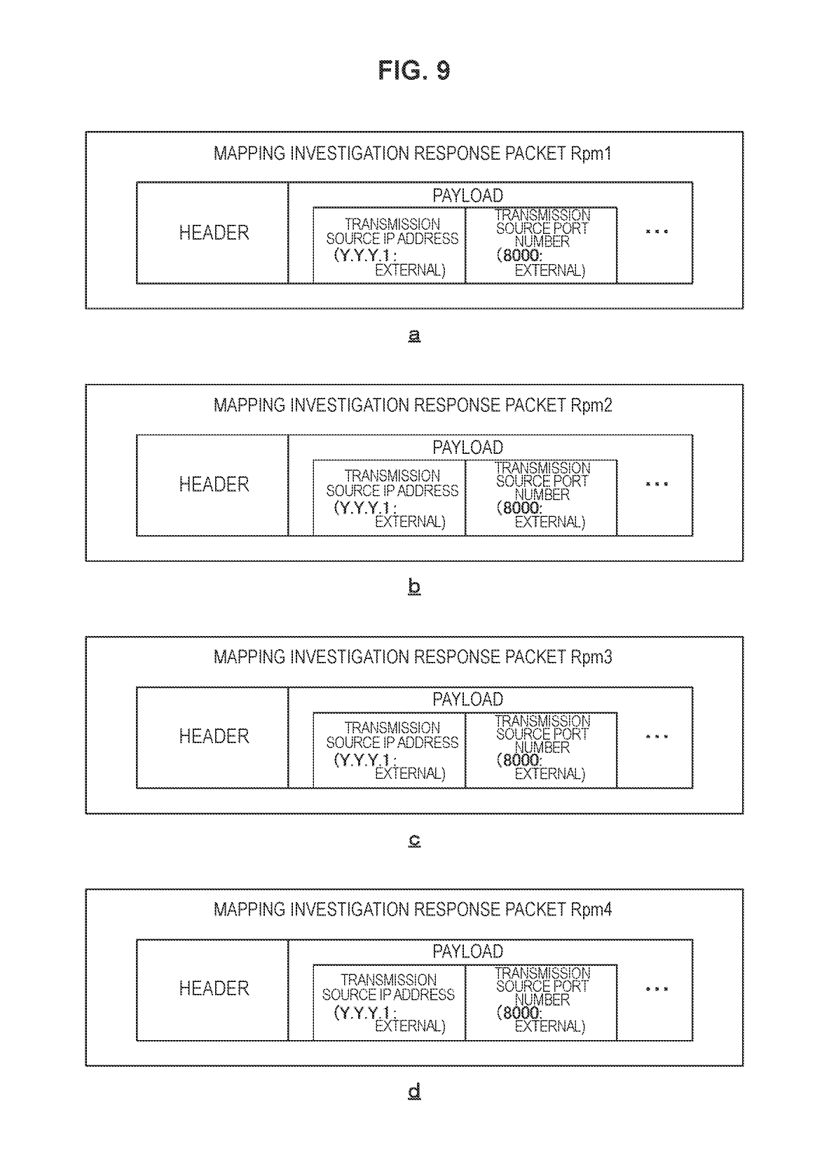

FIG. 9 is a view illustrating one example of the data structure of mapping investigation response packets at the time of the endpoint-independent mapping in the first embodiment. In FIG. 9, “a” shows one example of the data structure of mapping investigation response packet Rpm1. The transmission source IP address and the transmission source port number are stored in the payload of this mapping investigation response packet Rpm1. The transmission source IP address and the transmission source port number denote the external IP address and external port number assigned to the device 100 in the router 300.

In FIG. 9, “b” shows one example of the data structure of mapping investigation response packet Rpm2. In FIG. 9, “c” shows one example of the data structure of mapping investigation response packet Rpm3, and, in FIG. 9, “d” shows one example of the data structure of mapping investigation response packet Rpm4. The data structures of these packets are similar to mapping investigation response packet Rpm1. From this, it is guessed that the assignment of the external port number (i.e., port mapping) is not changed even if the destination is changed. Therefore, in this case, the endpoint-independent mapping is determined.

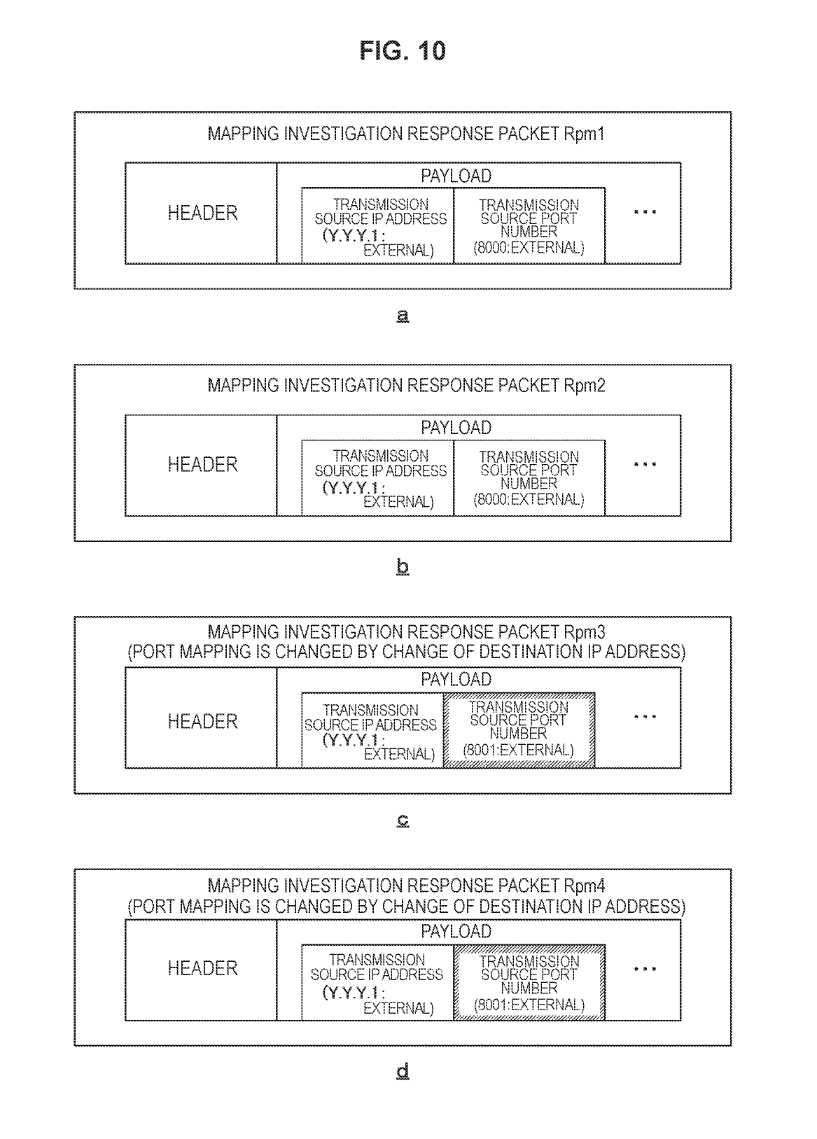

FIG. 10 is a view illustrating one example of the data structure of mapping investigation response packets at the time of the address-dependent mapping in the first embodiment. In FIG. 10, “a” shows one example of the data structure of mapping investigation response packet Rpm1, and, in FIG. 10, “b” shows one example of the data structure of mapping investigation response packet Rpm2. Moreover, in FIG. 10, “c” shows the one example of the data structure of mapping investigation response packet Rpm3, and, in FIG. 10, “d” shows one example of the data structure of mapping investigation response packet Rpm4.

In mapping investigation response packets Rpm1 and Rpm2, the external port number does not change. However, the external port number in mapping investigation response packet Rpm1 is different from the external port numbers in mapping investigation response packets Rpm3 and Rpm4. From this, it is guessed that the port mapping is changed according to the change in the destination IP address. Therefore, in this case, the address-dependent mapping is determined.

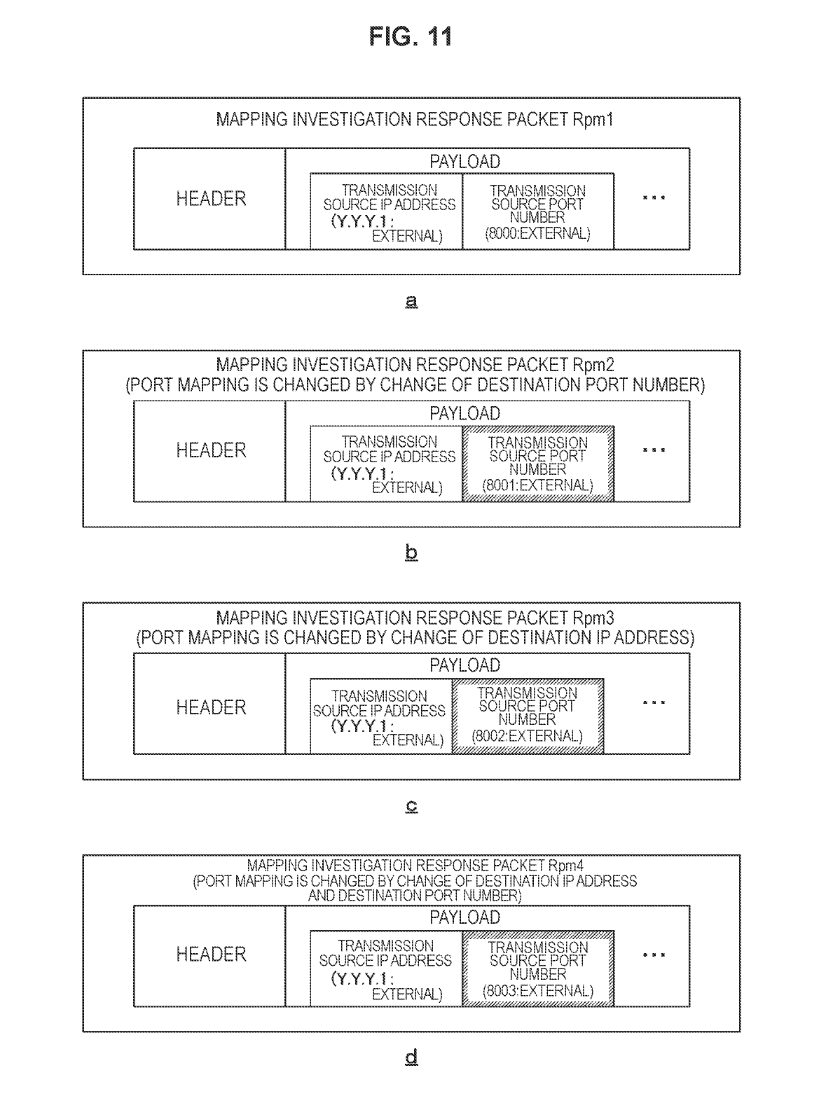

FIG. 11 is a view illustrating one example of the data structure of mapping investigation response packets at the time of the address-and-port-dependent mapping in the first embodiment. In FIG. 11, “a” shows one example of the data structure of mapping investigation response packet Rpm1, and, in FIG. 11, “b” shows one example of the data structure of mapping investigation response packet Rpm2. Moreover, in FIG. 11, “c” shows the one example of the data structure of mapping investigation response packet Rpm3, and, in FIG. 11, “d” shows one example of the data structure of mapping investigation response packet Rpm4.

The external port numbers of mapping investigation response packets Rpm1, Rpm2, Rpm3 and Rpm4 are different. Moreover, the difference between external port number “8000” of Rpm1 and external port number “8001” of next Rpm2 is “+1”. The difference between the external port numbers of Rpm2 and next Rpm3 is also “+1”, and the difference between the external port numbers of Rpm3 and Rpm4 is “+1”. From this, it is guessed that the port mapping is changed in a regular manner according to the change in the IP address or port number of the destination. Therefore, in this case, the address-and-port-dependent mapping is determined.

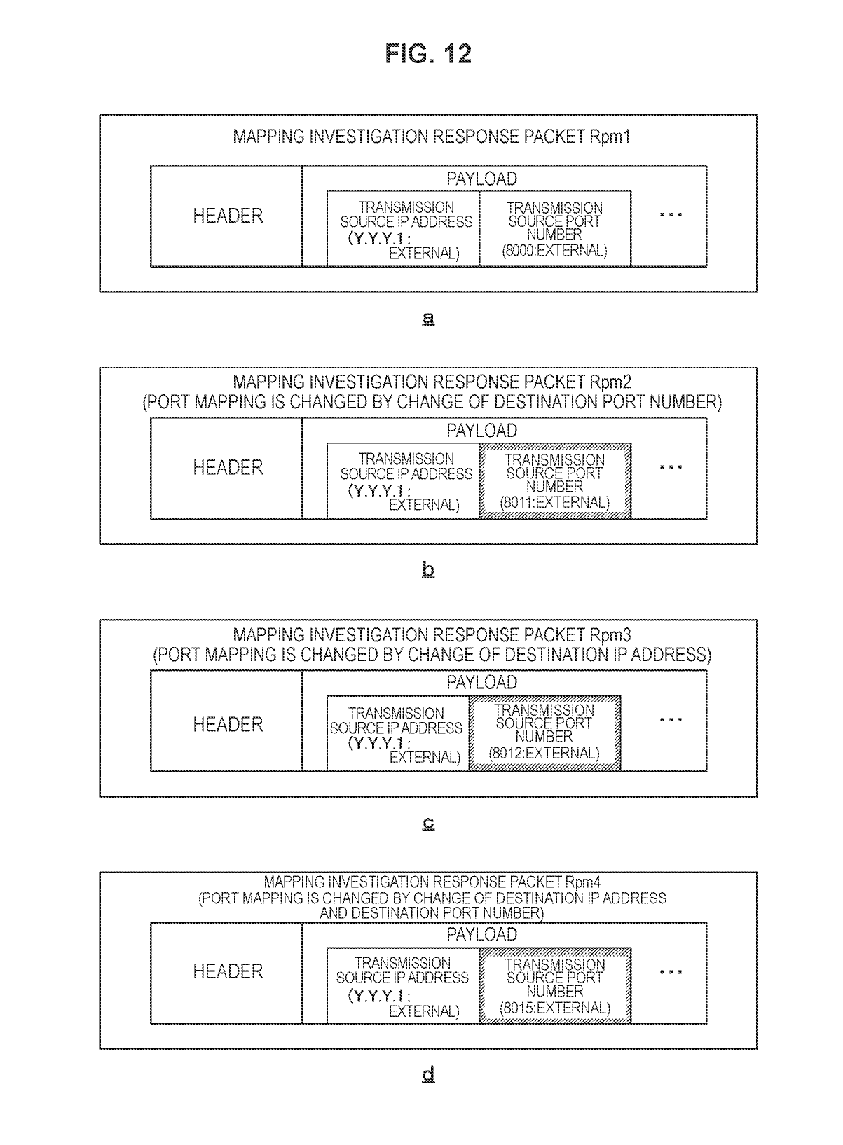

FIG. 12 is a view illustrating one example of the data structure of mapping investigation response packets at the time of the random mapping in the first embodiment. In FIG. 12, “a” shows one example of the data structure of mapping investigation response packet Rpm1, and, in FIG. 12, “b” shows one example of the data structure of mapping investigation response packet Rpm2. Moreover, in FIG. 12, “c” shows the one example of the data structure of mapping investigation response packet Rpm3, and, in FIG. 12, “d” shows one example of the data structure of mapping investigation response packet Rpm4.

The external port numbers of mapping investigation response packets Rpm1, Rpm2, Rpm3 and Rpm4 are different. Moreover, the difference between external port number “8000” of Rpm1 and external port number “8011” of next Rpm2 is “+11”. However, the difference between the external port numbers of Rpm2 and next Rpm3 is “+1”, and the difference between the external port numbers of Rpm3 and Rpm4 is “+3”. That is, the difference between adjacent external port numbers in the transmission order is not identical. From this, it is guessed that the port mapping is irregularly changed according to the change in the IP address or port number of the destination. Therefore, in this case, the random mapping is determined.

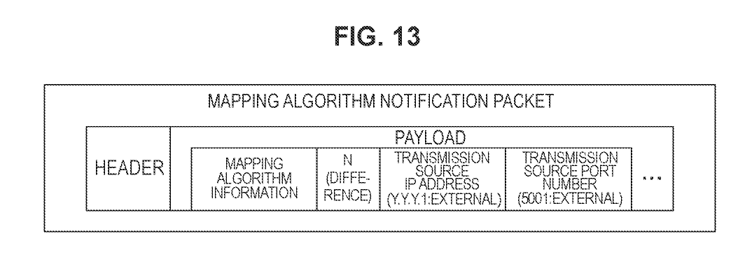

FIG. 13 is a view illustrating one example of the data structure of a mapping algorithm notification packet in the first embodiment. This mapping algorithm notification packet includes mapping algorithm information, N that is an integer, the transmission source IP address and the transmission source port number.

The mapping algorithm information denotes information that shows a mapping algorithm acquired by the device. “N” denotes the value of the difference between adjacent external port numbers in the transmission order of mapping investigation response packets. “N” is used to predict the external port number. However, in a case where the mapping algorithm is the endpoint-independent mapping or the random mapping, “N” is not stored because the prediction of the external port number is not requested or is not possible. Alternatively, in that case, an invalid value is set to N.

The transmission source IP address and the transmission source port number denote the external IP address and external port number of the device in last mapping investigation response packet Rpm4 in the transmission order. Here, the device 100 may notify the external IP address and the external port number by a packet different from the mapping algorithm notification packet.

[Configuration Example of Determination Table]

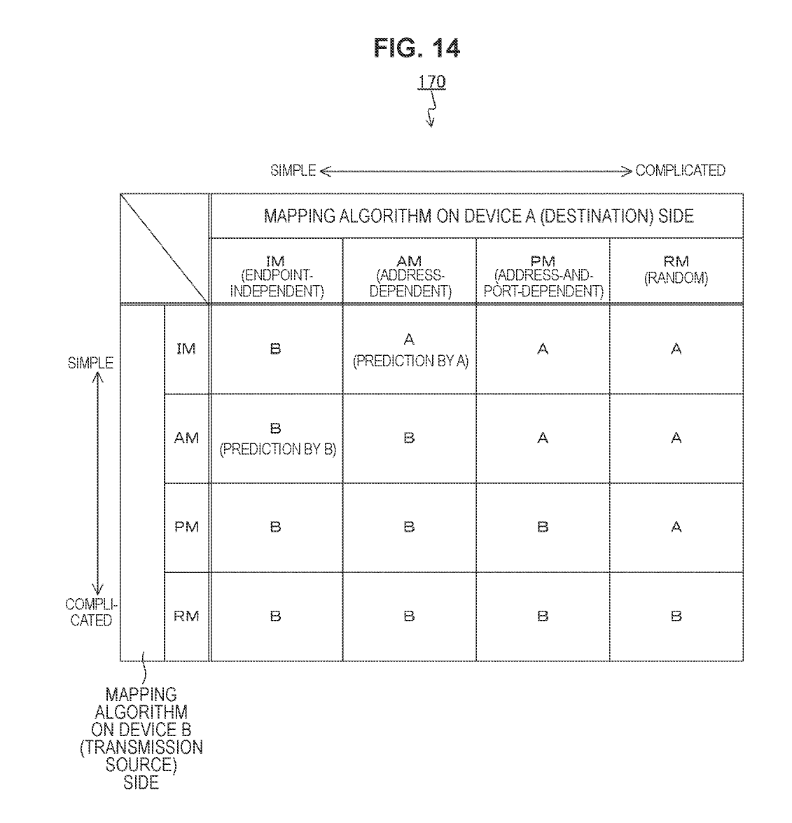

FIG. 14 is a view illustrating one configuration example of the determination table 170 in the first embodiment. This determination table 170 describes a flag showing whether to set the transmission source as a master, for each combination of the transmission source mapping algorithm and the destination mapping algorithm. In the determination table 170, the destination of a session establishment request packet forwarded through the server 500 is set as device A and the transmission source thereof is set as device B.

Moreover, “IM” stands for endpoint-independent mapping. “AM” stands for address-dependent mapping. “PM” stands for address-and-port-dependent mapping. “RM” stands for random mapping.

In a case where the destination mapping algorithm on the device A side is more complicated than the transmission source mapping algorithm on the device B side, a flag showing that device A is set as a master is recorded. This is because the mapping algorithm on the device B side is simpler and it is easier to predict the external port number in device A than device B.

By contrast, in a case where the destination mapping algorithm on the device B side is more complicated than the transmission source mapping algorithm on the device A side, a flag showing that device B is set as a master is recorded. Moreover, in a case where the destination mapping algorithm on the device B side is the same as the transmission source mapping algorithm on the device A side, a flag showing that device B is set as a master is recorded.

[Operation Example of Device]

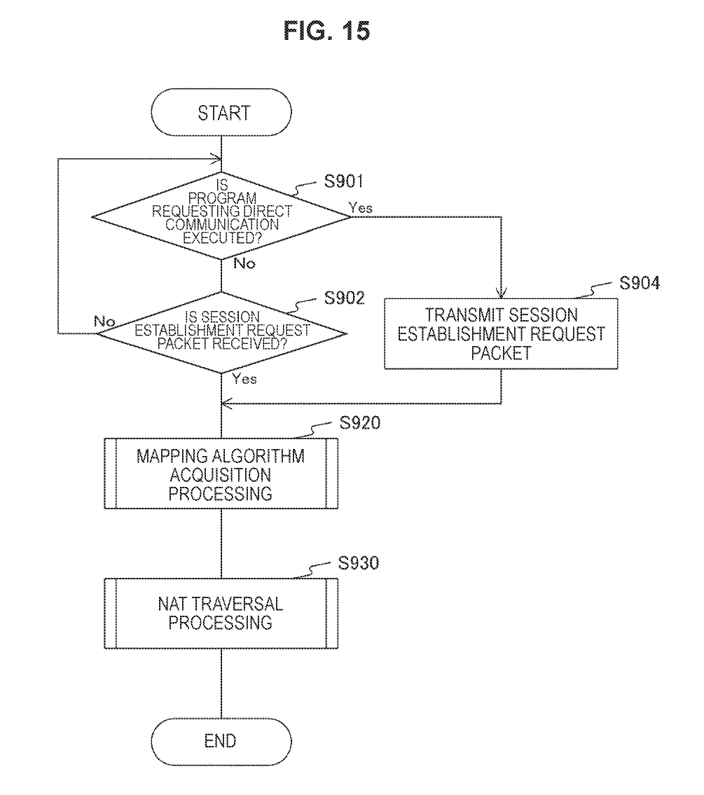

FIG. 15 is a flowchart illustrating one example of operation of the device 100 in the first embodiment. For example, this operation starts when the device 100 is connected with the server 500 through the router 300.

The device 100 determines whether a program requesting direct communication is executed. The program requesting direct communication is, for example, a program to perform communication competition in an online game or a program to start a telephone call in IP telephone, and so on (step S901).

If the program is not executed (step S901: No), the device 100 determines whether a session establishment request packet was received from the server 500 (step S902). If the session establishment request packet is not received (step S902: No), the device 100 returns to step S901.

If the program is executed (step S901: Yes), the device 100 generates a session establishment request packet that designates a device of the communication target, and transmits it to the server 500 (step S904).

In a case where the session establishment request packet is received (step S902: Yes) or after step S904, the device 100 executes mapping algorithm acquisition processing to acquire a mapping algorithm (step S920). Further, the device 100 performs NAT traversal processing to perform NAT traversal and direct communication (step S930). After step S930, the device 100 finishes the operation. Here, the operation of the device 101 is similar to the device 100.

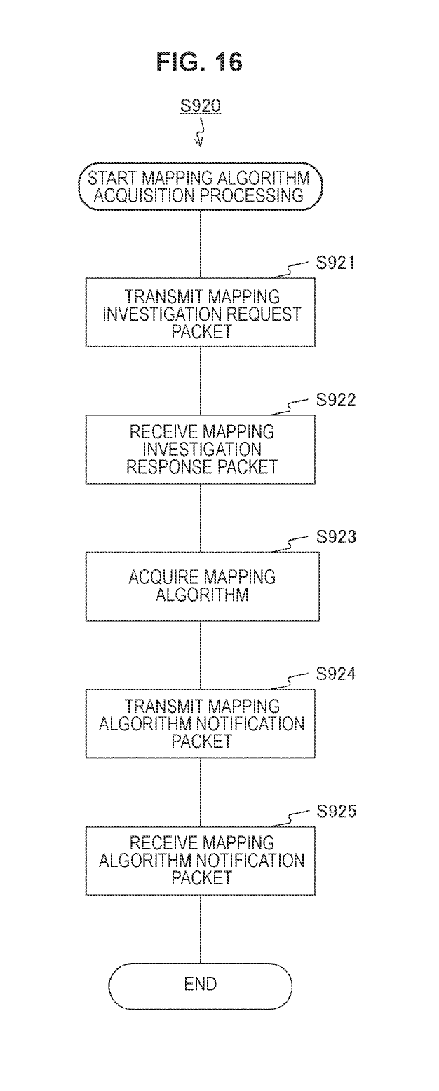

FIG. 16 is a flowchart illustrating one mapping algorithm acquisition processing in the first embodiment. The device 100 sequentially transmits a plurality of mapping investigation request packets to the server 500 (step S921). The device 100 receives a plurality of mapping investigation response packets (step S922). Further, the device 100 acquires a mapping algorithm on the device 100 side on the basis of those mapping investigation response packets (step S923). In step S923, the transmission source mapping algorithm is acquired if the device 100 is the transmission source of the session establishment request packet, and the destination mapping algorithm is acquired if it is the destination.

The device 100 generates a mapping algorithm notification packet that notifies the acquired mapping algorithm, and transmits it to the server 500(step S924). Also, the device 100 receives a mapping algorithm notification packet that notifies a mapping algorithm acquired by the device 101, from the server 500 (step S925). In step S925, the packet that notifies the destination mapping algorithm is received if the device 100 is the transmission source of the session establishment request packet, and the packet that notifies the transmission source mapping algorithm is received if it is the destination. After step S925, the device 100 finishes the mapping algorithm acquisition processing.

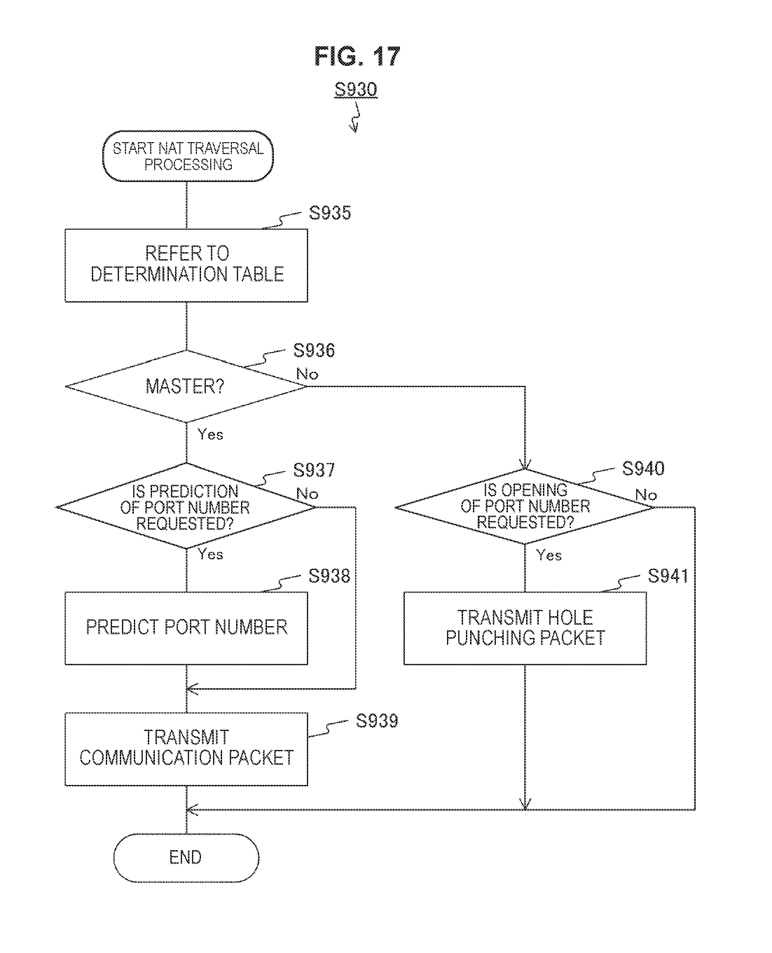

FIG. 17 is a flowchart illustrating one example of NAT traversal processing in the first embodiment. The device 100 refers to the determination table 170 and acquires a flag corresponding to a combination of a transmission source mapping algorithm and a destination mapping algorithm (step S935).

The device 100 determines whether to set the device 100 as a master, according to the flag (step S936). In a case where the device 100 is set as a master (step S936: Yes), the device 100 determines whether the external port number has to be predicted. For example, it is determined that the port number does not have to be predicted if the mapping algorithm on the slave side is the endpoint-independent mapping (step S937).

If the external port number has to be predicted (step S937: Yes), the device 100 predicts a new external port number assigned to the slave on the basis of a prediction algorithm corresponding to the mapping algorithm on the slave side (step S938).

In a case where the external port number does not have to be predicted (step S937: No), or, after step S938, the device 100 transmits a communication packet to the predicted external port number. In a case where the prediction is not requested, the device 100 transmits a communication packet using the external port number received from the slave through the server 500 as the destination as it is (step S939).

In a case where the device 100 is set as a slave (step S936: No), the device 100 determines whether the external port number has to be opened in the router 300 on the slave side. For example, if the mapping algorithm on the slave side is the endpoint-independent mapping, it is determined that the external port number does not have to be opened (step S940). If the port number has to be opened (step S940: Yes), the device 100 transmits a hole punching packet to the master (step S941).

In a case where the port number does not have to be opened (step S940: No), or, after step S941, the device 100 optionally transmits/receives a packet to/from the device 101 and finishes the NAT traversal processing.

[Operation Example of Server]

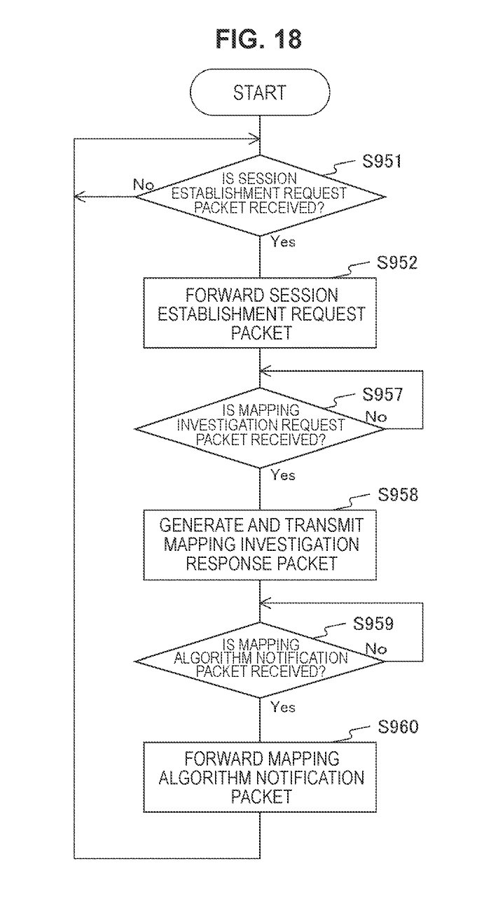

FIG. 18 is a flowchart illustrating one example of operation of the server 500 in the first embodiment. For example, this operation is started when devices such as the devices 100 and 101 are connected with the server 500 through the router 300 or the like.

The server 500 determines whether to have received a session establishment request packet (step S951). If the session establishment request packet is not received (step S951: No), the server 500 returns to step S951.

If the session establishment request packet was received (step S951: Yes), the server 500 forwards the session establishment request packet to a device specified as a communication target in the packet (step S952).

Further, the server 500 determines whether to have received a plurality of mapping investigation request packets (step S957). If the mapping investigation request packets are not received (step S957: No), the server 500 returns to step S957. If the plurality of mapping investigation request packets were received (step S957: Yes), the server 500 generates and returns mapping investigation response packets according to those packets (step S958).

Further, the server 500 determines whether to have received a mapping algorithm notification packet (step S959). If the mapping algorithm notification packet is not received (step S959: No), the server 500 returns to step S959. If the mapping algorithm notification packet was received (step S959: Yes), the server 500 forwards the mapping algorithm notification packet (step S960). After step S960, the server 500 returns to step S951.

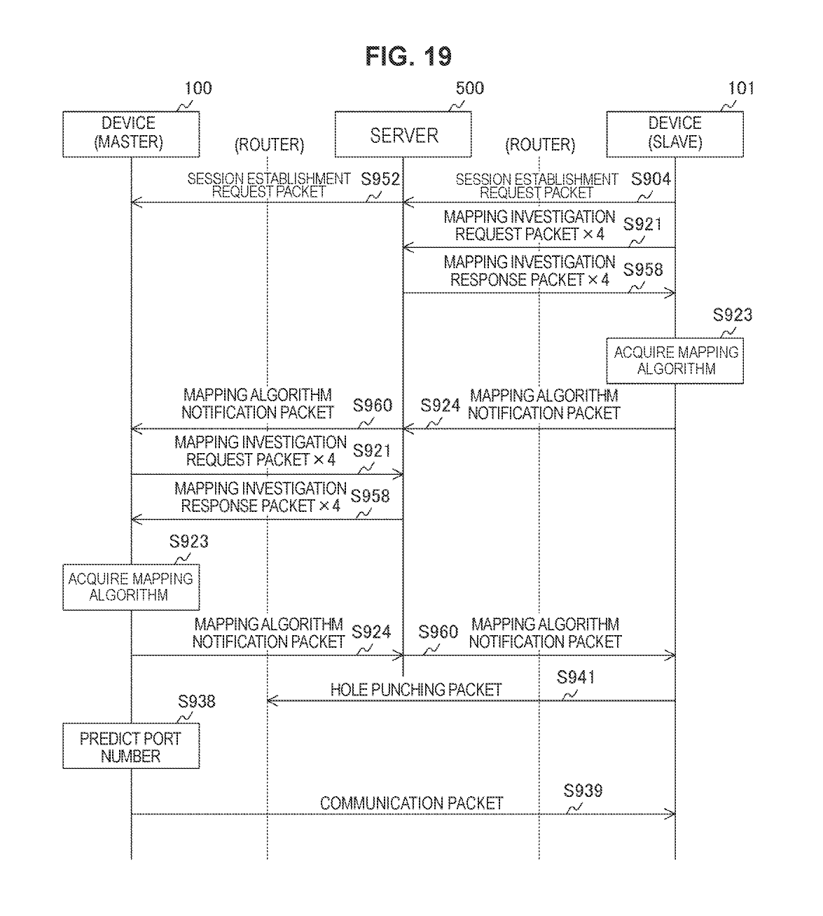

FIG. 19 is a sequence diagram illustrating one example of operation of the server and device in the first embodiment. In this figure, a case is assumed where the device 100 is determined as a master and the device 101 is determined as a slave.

The device 101 transmits a session establishment request packet that designates the device 100 to the server 500 (step S904). The server 500 forwards the session establishment request packet to the device 100 (step S952).

Further, the device 100 generates four mapping investigation request packets and sequentially transmits them to the server 500 through the router 301 (step S921). The internal IP addresses and internal port numbers of the transmission sources of these packets are converted into the external IP addresses and external port numbers in the router 301.

The server 500 returns mapping investigation response packets that store the converted external IP addresses and external port numbers, to the device 101 (step S958).

The device 101 acquires a transmission source mapping algorithm on the basis of the mapping investigation response packets (step S923). The device 101 transmits a mapping algorithm notification packet that notifies the mapping algorithm, to the server 500 (step S924).

The server 500 forwards the mapping algorithm notification packet from the device 101, to the device 100 (step S960).

Meanwhile, the device 100 also sequentially transmits four mapping investigation request packets to the server 500 (step S921), and the server 500 returns mapping investigation response packets to the device 100 (step S958).

Further, the device 101 acquires a destination mapping algorithm (step S923) and transmits a mapping algorithm notification packet to the server 500 (step S924). The server 500 forwards the mapping algorithm notification packet from the device 100, to the device 101 (step S960).

Referring to the determination table 170, the device 100 becomes a master and the device 101 becomes a slave. The device 101 of the slave transmits a hole punching packet to the device 100 (step S941).

Meanwhile, the device 100 predicts an external port number released by the hole punching packet (step S938). Further, the device 100 transmits a communication packet to the predicted external port number (step S939).

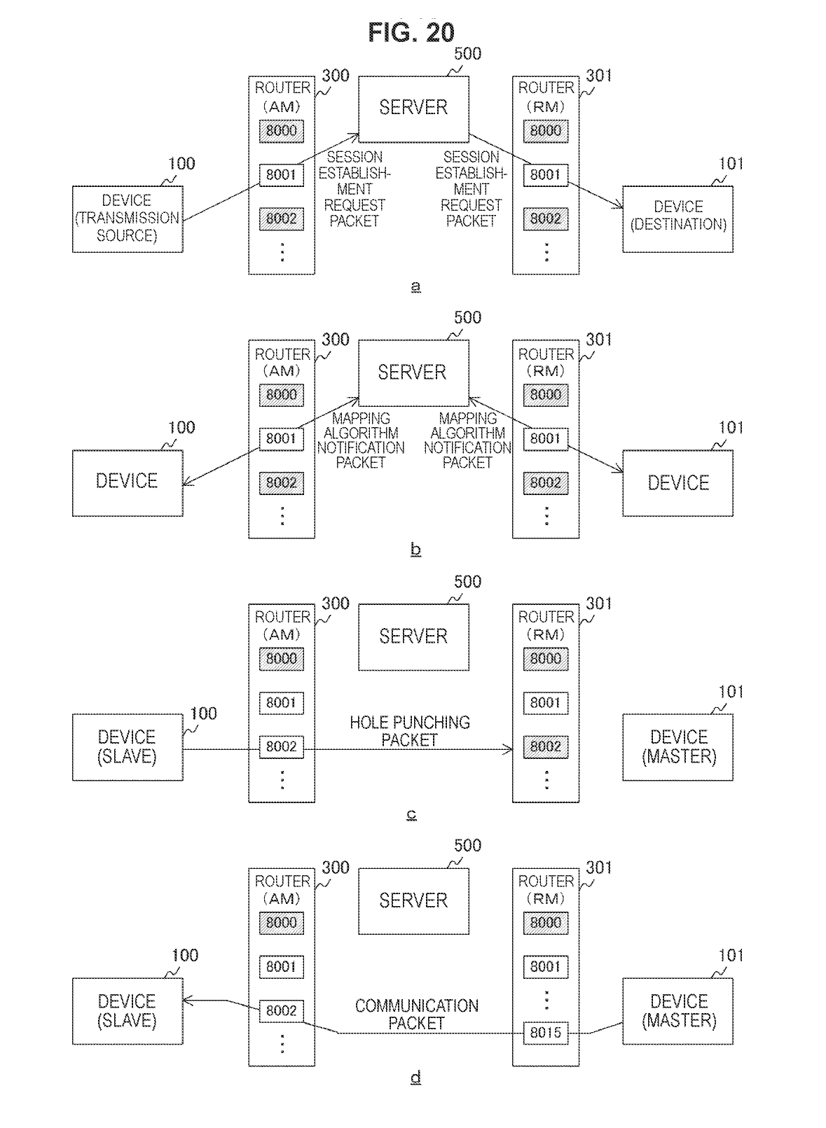

FIG. 20 is a view illustrating one example of the usage state of external port numbers in the first embodiment. In FIG. 20, “a” shows a view illustrating one example of the usage state of the external port numbers when a session establishment request packet is transmitted and received. It is assumed that the router 300 registers port number “8001” and the server 500 in association with the device 100. Moreover, it is assumed that the router 301 registers port number “8001” and the server 500 in association with the device 101.

The device 100 transmits a session establishment request packet to the server 500. The internal port number of the transmission source of this session establishment request packet is converted into “8001” in the router 300. The server 500 forwards the session establishment request packet to the device 101. External port number “8001” of the transmission source of this session establishment request packet is converted into the internal port number of the device 101 in the router 301.

Further, the devices 100 and 101 acquire mapping algorithms respectively, and notify the mapping algorithms to each other through the server 500 by mapping algorithm notification packets.

In FIG. 20, “b” shows a view illustrating one example of the usage state of the external port numbers when the mapping algorithm notification packets are transmitted and received. The usage state of the external ports at this time is similar to “a” in FIG. 20.

Here, a case is assumed where the address-dependent mapping (AM) is acquired as a mapping algorithm of the router 300 and the random mapping (RM) is acquired as a mapping algorithm of the router 301. In this case, since the address-dependent mapping of the router 300 is simpler, the device 101 as a master predicts a new external port number assigned to the device 100 in the router 300. Meanwhile, the device 100 of the slave transmits a hole punching packet to the device 101.

In FIG. 20, “c” shows a view illustrating one example of the usage state of the external port numbers when the hole punching packet is transmitted. Since the destination IP address of the hole punching packet is different from the IP address of the server 500, the router 300 newly assigns external port number “8002” to the device 100. The slave adjusts TTL such that the hole punching packet does not reach the router 301.

The device 101 of the master predicts external port number “8002” newly assigned to the device 100, from previous external port number “8001” of the device 100. The device 101 transmits a communication packet to the external port number.

In FIG. 20, “d” shows a view illustrating one example of the usage state of the external port numbers when the communication packet is transmitted. In the router 300, since predicted external port number “8002” is released, the communication packet is delivered to the device 100 of the slave.

Here, a configuration is provisionally considered where the transmission source device (100) becomes a master and the destination device (101) operates as a slave, without referring to the determination table 170. In this case, the device 101 of the slave transmits a hole punching packet and the external port number of the router 301 is released.

However, since the mapping algorithm of the router 301 is the random mapping, the device 100 is not possible to predict which external port number is released. Therefore, the communication packet transmitted by the device 100 does not reach the device 101 of the slave and direct communication fails.

By contrast with this, since the device 100 or 101 compares the complexity of both mapping algorithms and predicts the external port number on the basis of a prediction algorithm corresponding to the simpler mapping algorithm, the direct communication succeeds at high possibility.

Thus, according to the first embodiment of the present disclosure, the device 100 or 101 generates the external port number on the basis of a prediction algorithm corresponding to the simpler one of transmission source and destination mapping algorithms. Therefore, it is possible to improve the probability of succeeding in direct communication.

### 2. Second Embodiment

### Configuration Example of Router

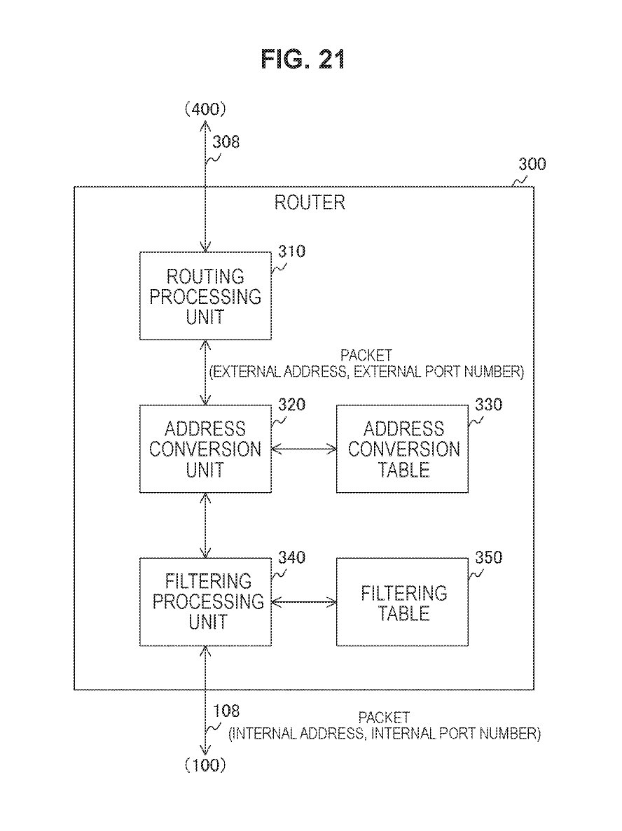

FIG. 21 is a block diagram illustrating one configuration example of the router 300 in the second embodiment. Although a configuration is adopted in the first embodiment where the router 300 does not perform filtering processing, the filtering processing is often performed in the router 300. In a case where the router 300 performs the filtering processing, the device 100 determines whether to set a master, taking into account the filtering processing.

The router 300 of the second embodiment is different from the first embodiment in further including a filtering processing unit 340 and a filtering table 350. The configuration of the router 301 in the second embodiment is similar to the router 300.

The filtering processing unit 340 performs filtering processing to determine whether to cause packets to pass, and discard a packet not to pass. When receiving a packet from the inside of a LAN to the outside, this filtering processing unit 340 refers to the filtering table 350 and determines whether to cause the packet to pass. Further, the filtering processing unit 340 supplies the packet to pass to the address conversion unit 320. Moreover, when receiving a packet in which the IP address and the port number are converted from the address conversion unit 320, the filtering processing unit 340 refers to the filtering table 350 and determines whether to cause the packet to pass. Further, the filtering processing unit 340 forwards the packet to pass to the inside of the LAN.

The filtering table 350 denotes a table that stores information showing whether to cause packets to pass for each of combinations of the transmission sources and destinations of the packets.

Here, in the filtering processing, any one filtering algorithm of endpoint-independent filtering, address-dependent filtering and address-and-port-dependent filtering is used.

In the endpoint-independent filtering, when a packet is transmitted from device S in the LAN to the outside once, the router 300 causes the packet to pass from the outside into device S without depending on the transmission source of the packet.

Here, a case is considered where there are a device with (internal IP address: internal port number) of (X1: x1), a device with (external IP address: external port number) of (Y1: y1) and a device with (external IP address: external port number) of (Y2: y2).

For example, when a packet is transmitted from (X1: x1) to (Y1: y1) in the initial state, a packet from the outside, whose destination is (X1: x1), is permitted in the filtering table 350 regardless of the transmission source. Therefore, the router 300 causes both a packet from (Y1: y1) to (X1: x1) and a packet of a different transmission source from (Y2: y2) to (X1: x1) to pass.

Next, in the address-dependent filtering, when a packet is transmitted from device S inside the LAN to outside device D, the router 300 causes only packets from a transmission source of the same IP address as device D to device S to pass.

For example, when a packet is transmitted from (X1: x1) to (Y1: y1) in the initial state, a packet from the outside, whose transmission source is Y1 and destination is (X1: x1), is permitted in the filtering table 350. Therefore, although the router 300 causes a packet from (Y1: y1) to (X1: x1) to pass, it does not cause a packet from (Y2: y2) whose IP address is different to (X1: x1) to pass. Moreover, a packet from (Y1: y2) whose port number is different to (X1: x1) has the identical IP address and is therefore caused to pass.

Further, in the address-and-port-dependent filtering, when a packet is transmitted from device S inside the LAN to outside device D, the router 300 causes only packets from a transmission source of the same IP address and port number as device D to device S to pass.

For example, when a packet is transmitted from (X1: x1) to (Y1: y1) in the initial state, a packet from the outside, whose transmission source is (Y1: y1) and destination is (X1: x1), is permitted in the filtering table 350. Therefore, although the router 300 causes a packet from (Y1: y1) to (X1: x1) to pass, it does not cause a packet from (Y2: y2) whose IP address is different to (X1: x1) to pass. Moreover, since a packet from (Y1: y2) to (X1: x1) has a different port number, the router 300 does not cause it to pass.

Thus, these filtering algorithms are different in the complexity. The address-dependent mapping in which a packet is not caused to pass when the IP address of the transmission source changes, is more complicated than the endpoint-independent mapping in which a packet is caused to pass even if the transmission source changes. The address-and-port-dependent mapping in which a packet is not caused to pass when the port number of the transmission source changes, is more complicated than the address-dependent mapping in which a packet is caused to pass even if the port number of the transmission source changes.

That is, when they are arranged in order of complexity degree, they are arranged in order from the address-and-port-dependent filtering, the address-dependent filtering to the endpoint-independent filtering.

As the filtering algorithm becomes more complicated, it becomes more difficult to cause a communication packet to pass. Specifically, in the endpoint-independent filtering, since a packet is caused to pass even if the transmission source changes, the existence of filtering may be hardly taken into account. However, in the address-dependent filtering, since a packet is discarded when the IP address of the transmission source changes, the slave has to permit a communication packet from the master by a hole punching packet. Moreover, in the address-and-port-dependent filtering, the slave has to predict the external port number released on the master side and transmit a hole punching packet to the external port number.

Therefore, it is desirable that the device 100 or 101 transmits a communication packet to a router that performs filtering by the simpler algorithm.

For example, a case is considered where the filtering algorithm of the router 301 supporting the device 101 is more complicated than the filtering algorithm of the router 300 supporting the device 100. In this case, it is desirable that the device 101 becomes a master and transmits a communication packet through the router 300 that perform the simpler filtering.

[Configuration Example of Filtering Table]

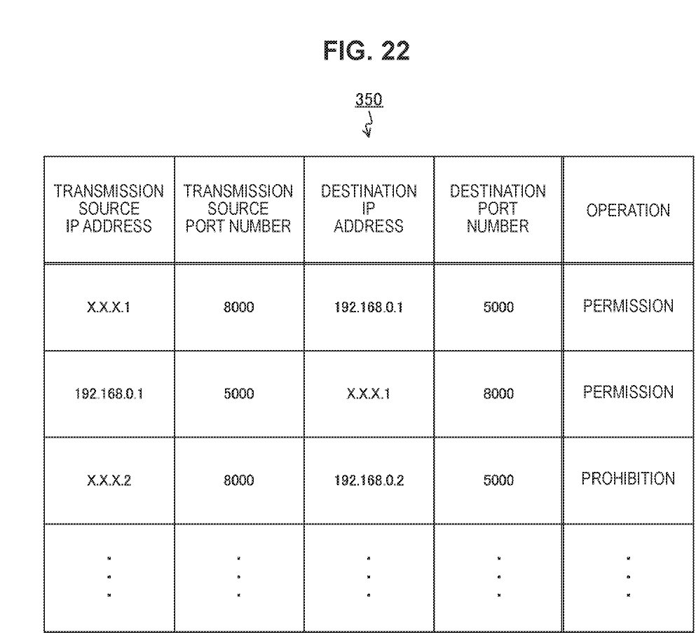

FIG. 22 is a view illustrating one configuration example of the filtering table 350 in the second embodiment. This filtering table 350 stores information showing “operation” as to whether to permit a packet, for each combination of the transmission source IP address, the transmission source port number, the destination IP address and the address port number. For example, the operation includes “permission” and “prohibition” of packet pass.

For example, a case is considered where a packet is transmitted from a device in a LAN, whose internal IP address is “192.168.0.1” and external port number is “5000”, to the outside in the initial state. It is assumed that the external IP address of the destination of the packet is “X.X.X.1” and the external port number is “8000”.

In this case, in the endpoint-independent filtering, information showing that the IP address and port number of the transmission source are both set to “any” and packets with destination of “192.168.0.1” and “5000” are permitted, is registered. Here, “any” means that any IP address or port number is targeted for permission or prohibition.

In the address-dependent filtering, information showing that the transmission source is set as “X.X.X.1” and “any” and packets with destination of “192.168.0.1” and “5000” are permitted, is registered.

In the address-and-port-dependent filtering, information showing that the transmission source is set as “X.X.X.1” and “8000” and packets with destination of “192.168.0.1” and “5000” are permitted, is registered.

[Configuration Example of Server]

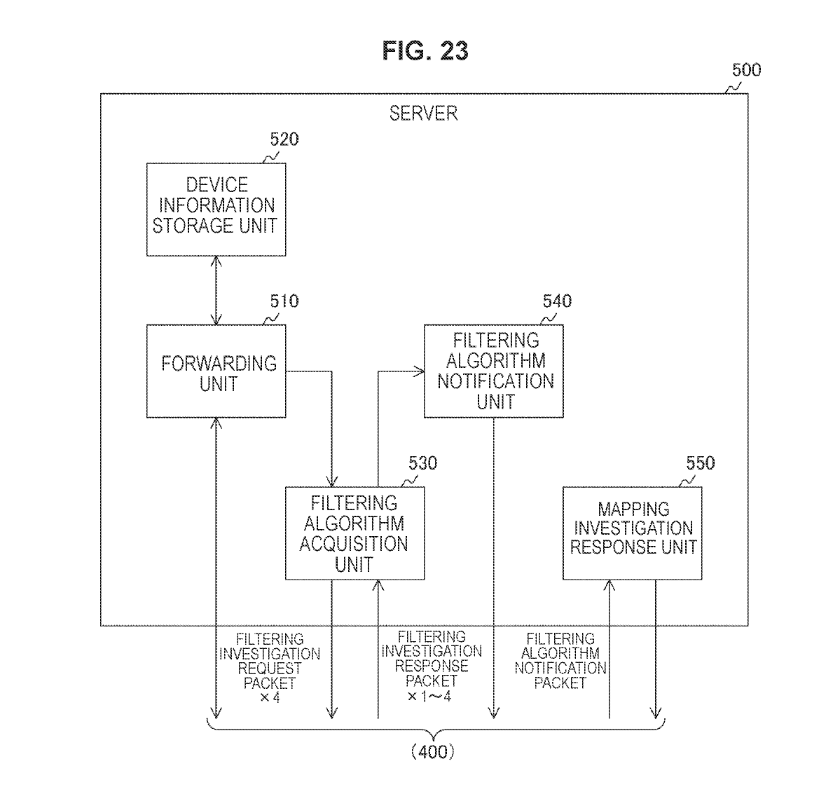

FIG. 23 is a block diagram illustrating one configuration example of the server 500 in the second embodiment. The server 500 of the second embodiment is different from the first embodiment in further including a filtering algorithm acquisition unit 530 and the filtering algorithm notification unit 540.

The filtering algorithm acquisition unit 530 acquires the filtering algorithm in each of routers. This filtering algorithm acquisition unit 530 receives the external IP address and the external port number from the forwarding unit 510, with respect to each of the transmission source and destination of a session establishment request packet.

The filtering algorithm acquisition unit 530 transmits a plurality of packets that request a reply, to those external IP addresses and external port numbers, as filtering investigation request packets. As described above, a filtering method when the transmission source changes, varies every filtering algorithm. To determine this algorithm difference, the plurality of filtering investigation request packets are transmitted from respective transmission sources by the server 500.

For example, four filtering investigation request packets Rqf1, Rqf2, Rqf3 and Rqf4 of different transmission sources are sequentially transmitted. Rqf2 denotes a packet in which the IP address of the transmission source is the same as Rqf1 and the port number of the transmission source is different from Rqf1. Rqf3 denotes a packet in which the IP address of the transmission source is different from Rqf1 and the port number of the transmission source is the same as Rqf1. Rqf4 denotes a packet in which the IP address and port number of the transmission source are both different from Rqf1.

The filtering algorithm acquisition unit 530 receives filtering investigation response packets Rpf1, Rpf2, Rpf3, and Rpf4 which are returned in response to filtering investigation request packets Rqf1, Rqf2, Rqf3 and Rqf4. However, there is a case where some response packets are not able to be received depending on the filtering algorithm. The filtering algorithm acquisition unit 530 acquires the filtering algorithm on the basis of the reception state of the response packets.

Specifically, when all of filtering investigation response packets Rpf1, Rpf2, Rpf3 and Rpf4 are received, the endpoint-independent filtering is determined. This is because packets are permitted to pass in this endpoint-independent filtering even if the transmission source changes.

Moreover, in a case where filtering investigation response packets Rpf3 and Rpf4 are not received though filtering investigation response packets Rpf1 and Rpf2 are received, the address-dependent filtering is determined. This is because packets are not permitted to pass in this address-dependent filtering when the IP address of the transmission source changes.

Moreover, in a case where only filtering investigation response packet Rpf1 is received, the address-and-port-dependent is determined. This is because packets are not permitted to pass in this address-and-port-dependent filtering when the IP address or port number of the transmission source changes.

The filtering algorithm acquisition unit 530 acquires filtering algorithms of routers on the transmission source side and destination side of a session establishment request packet. In the following, the filtering algorithm of the router on the transmission source side is referred to as “transmission source filtering algorithm” and the filtering algorithm of the router on the destination side is referred to as “address filtering algorithm”. The filtering algorithm acquisition unit 530 supplies the acquired filtering algorithms to the filtering algorithm notification unit 540 together with the external IP addresses and external port numbers of the transmission source and the destination.

Here, although the filtering algorithm acquisition unit 530 acquires the filtering algorithms by transmitting the filtering investigation request packets and receiving the response packets, it is not limited to this configuration. For example, the filtering algorithm acquisition unit 530 may acquire the filtering algorithms by the use of the STUN protocol.

The filtering algorithm notification unit 540 notifies the acquired filtering algorithms to devices. This filtering algorithm notification unit 540 generates a filtering algorithm notification packet that stores the transmission source filtering algorithm and the destination filtering algorithm. Further, the filtering algorithm notification unit 540 transmits the filtering algorithm notification packet to the transmission source and destination of the session establishment request packet.

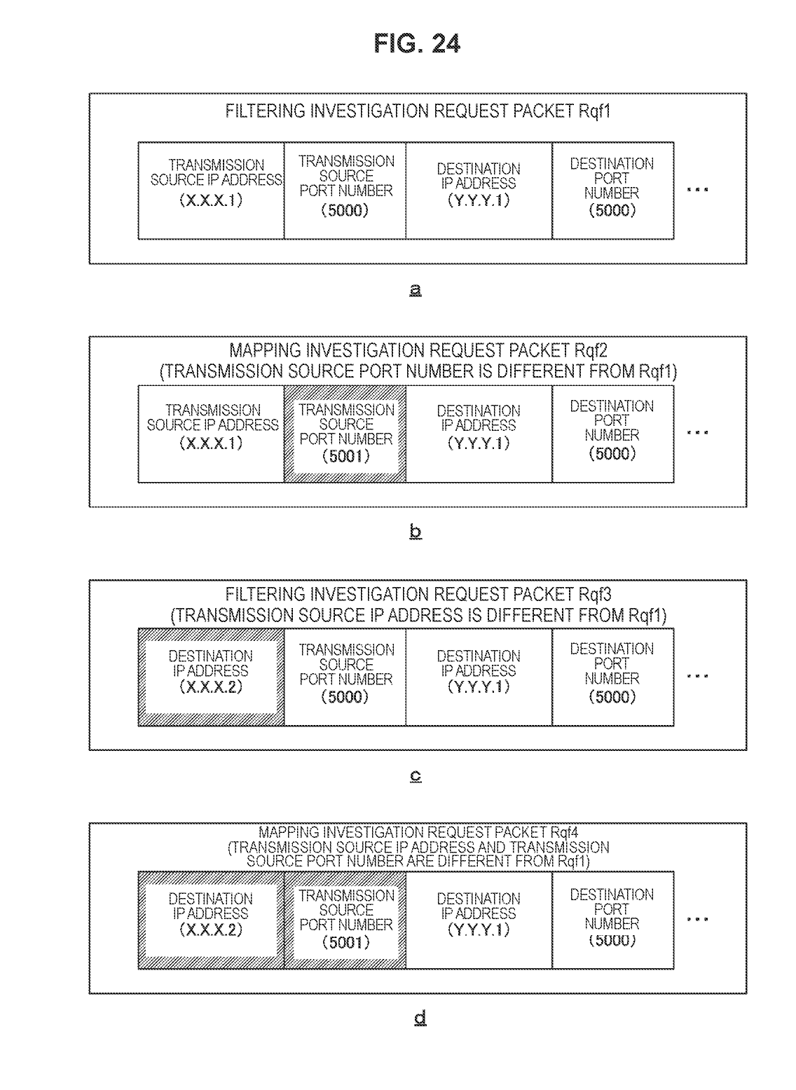

FIG. 24 is a view illustrating one example of the data structures of filtering investigation request packets in the second embodiment. In FIG. 24, “a” shows a view illustrating one example of the data structure of filtering investigation request packet Rqf1. This packet includes the transmission source IP address, the transmission source port number, the destination IP address and the address port number in the header. These transmission source IP address and transmission source port number are the IP address and port number of the server 500. Moreover, the destination IP address and the address port number are the external IP address and external port number of the router 300 or 301.

In FIG. 24, “b” shows a view illustrating one example of the data structure of filtering investigation request packet Rqf2. Filtering investigation request packet Rqf2 has a configuration similar to filtering investigation request packet Rqf1, except for that the transmission source port numbers are different.

In FIG. 24, “c” shows a view illustrating one example of the data structure of filtering investigation request packet Rqf3. Filtering investigation request packet Rqf3 has a configuration similar to filtering investigation request packet Rqf1, except for that the transmission source IP addresses are different.

In FIG. 24, “d” shows a view illustrating one example of the data structure of filtering investigation request packet Rqf4. Filtering investigation request packet Rqf4 has a configuration similar to filtering investigation request packet Rqf1, except for that the transmission source IP addresses and the transmission source port numbers are different.

The server 500 can acquire respective filtering algorithms of the routers 300 and 301 from filtering investigation response packets with respect to these filtering investigation request packets.

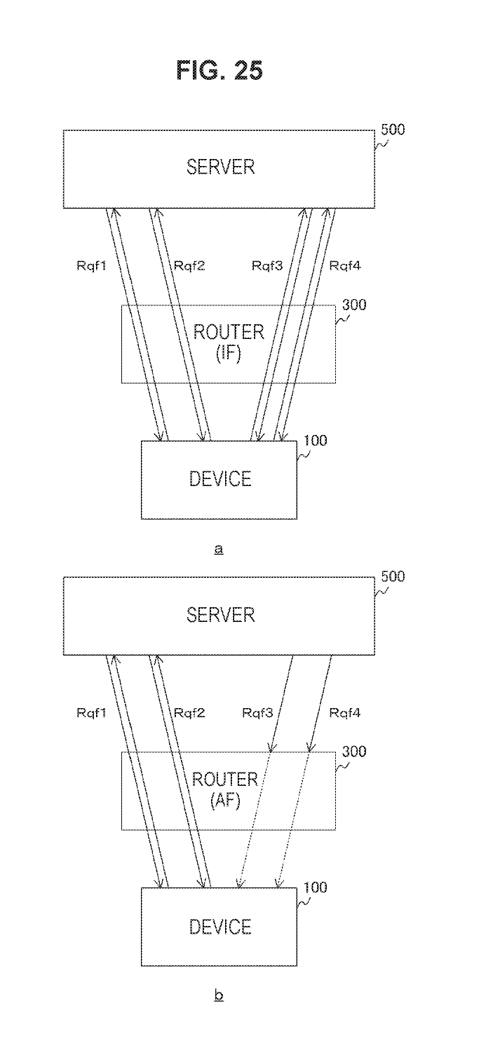

FIG. 25 is a view illustrating one example of packets processed by the endpoint-independent filtering and the address-dependent filtering in the second embodiment. In FIG. 25, “a” shows a view illustrating one example of packets processed by the endpoint-independent filtering. In the endpoint-independent filtering, all of four filtering investigation request packets of different transmission sources are permitted. Therefore, response packets with respect to all of the filtering investigation request packets are received.

In FIG. 25, “b” shows a view illustrating one example of packets processed by the address-dependent filtering. In the address-dependent filtering, filtering investigation request packets Rqf1 and Rqf2 with the same transmission source IP address are permitted. However, filtering investigation request packets Rqf3 and Rqf4 with transmission source IP addresses different from Rqf1 are discarded without being permitted. Therefore, the server 500 can receive only filtering investigation response packets Rpf1 and Rpf2.

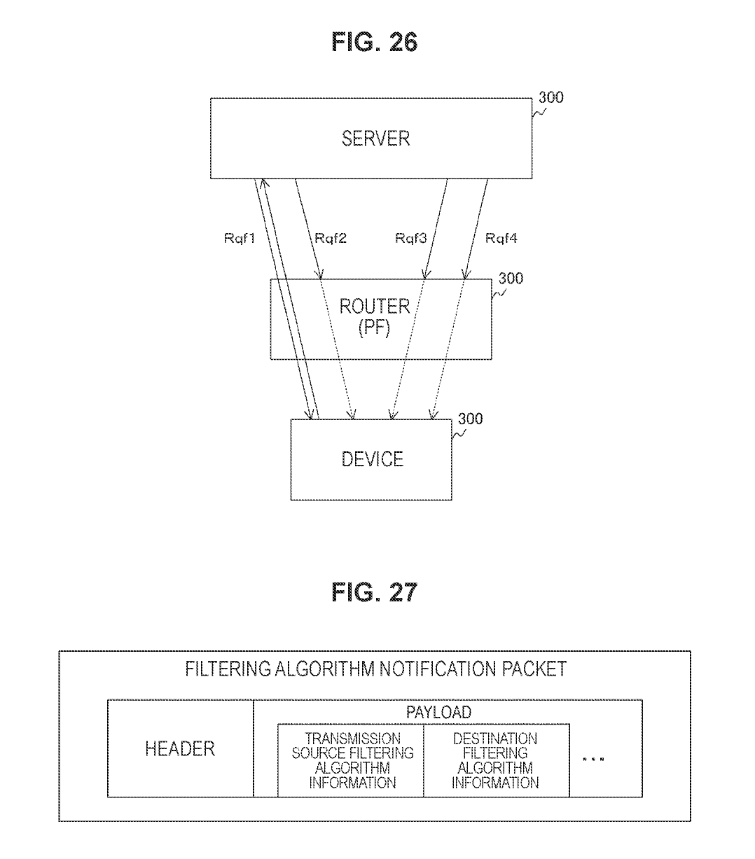

FIG. 26 is a view illustrating one example of packets processed by the address-and-port-dependent filtering in the second embodiment. In the address-and-port-dependent filtering, filtering investigation request packets Rqf2, Rqf3 and Rqf4 in which the transmission source IP address or port number is different from Rqf1, are discarded without being permitted. Therefore, the server 500 can receive only filtering investigation response packet Rpf1.

As exemplified in FIG. 25 and FIG. 26, since the reception state of filtering investigation response packets varies depending on the filtering algorithm, the server 500 can acquire the filtering algorithm from the reception state.

FIG. 27 is a view illustrating one example of the data structure of a filtering algorithm notification packet in the second embodiment. This filtering algorithm notification packet includes transmission source filtering algorithm information and destination filtering algorithm information. The transmission source filtering algorithm information denotes information to identify a transmission source algorithm. The destination filtering algorithm information denotes information to identify a destination algorithm.

[Configuration Example of Device]

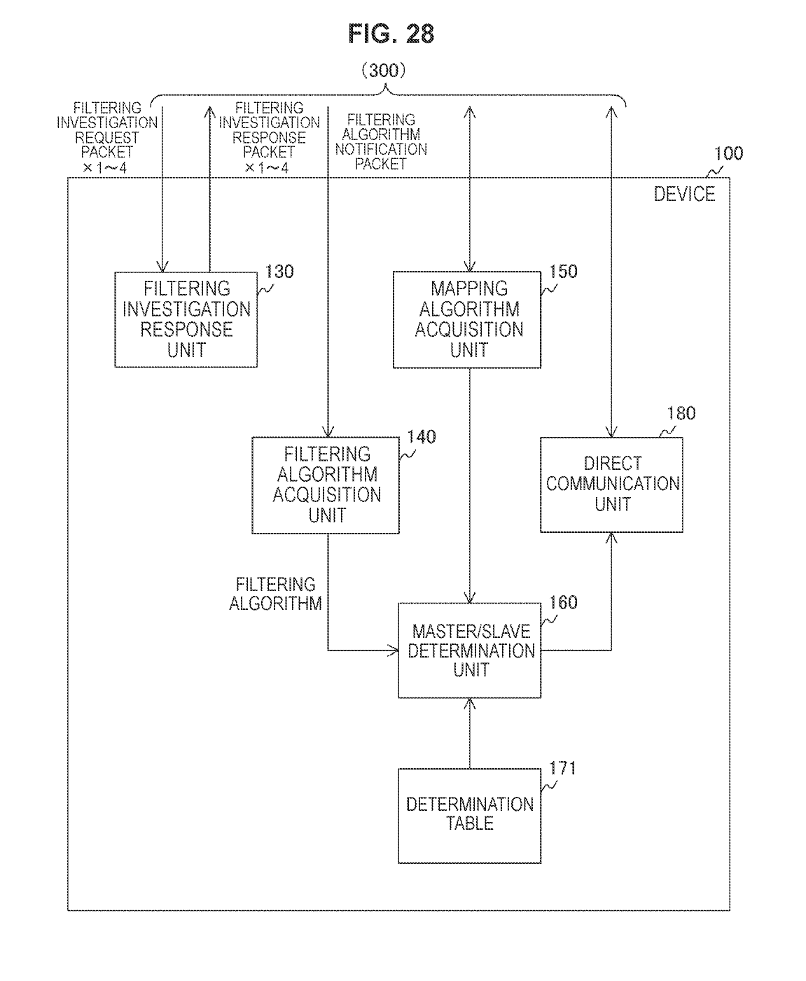

FIG. 28 is a block diagram illustrating one configuration example of the device 100 in the second embodiment. The device 100 of the second embodiment differs from the first embodiment in further including a filtering investigation response unit 130, a filtering algorithm acquisition unit 140 and a determination table 171 instead of the determination table 170. The configuration of the device 101 of the second embodiment is similar to the device 100.

The filtering investigation response unit 130 makes a reply to filtering investigation request packets. When receiving the filtering investigation request packets from the server 500, this filtering investigation response unit 130 generates filtering investigation response packets and returns them to the server 500.

The filtering algorithm acquisition unit 140 acquires a transmission source filtering algorithm and a destination filtering algorithm. When receiving a filtering algorithm notification packet, this filtering algorithm acquisition unit 140 acquires the filtering algorithms of the transmission source and the destination from the packet and supplies them to the master/slave determination unit 160.

Moreover, the determination table 171 of the second embodiment stores a flag for each combination of the transmission source mapping algorithm, the transmission source filtering algorithm, the destination mapping algorithm and the destination filtering algorithm.

Here, although the device 100 has a configuration including the filtering investigation response unit 130, instead of the device 100, other devices than the device 100 may have a configuration including the filtering investigation response unit 130. This is because any devices can make a reply to the filtering investigation request packets to investigate filtering of the router 300 as long as the devices are under the control of the router 300.

[Configuration Example of Determination Table]

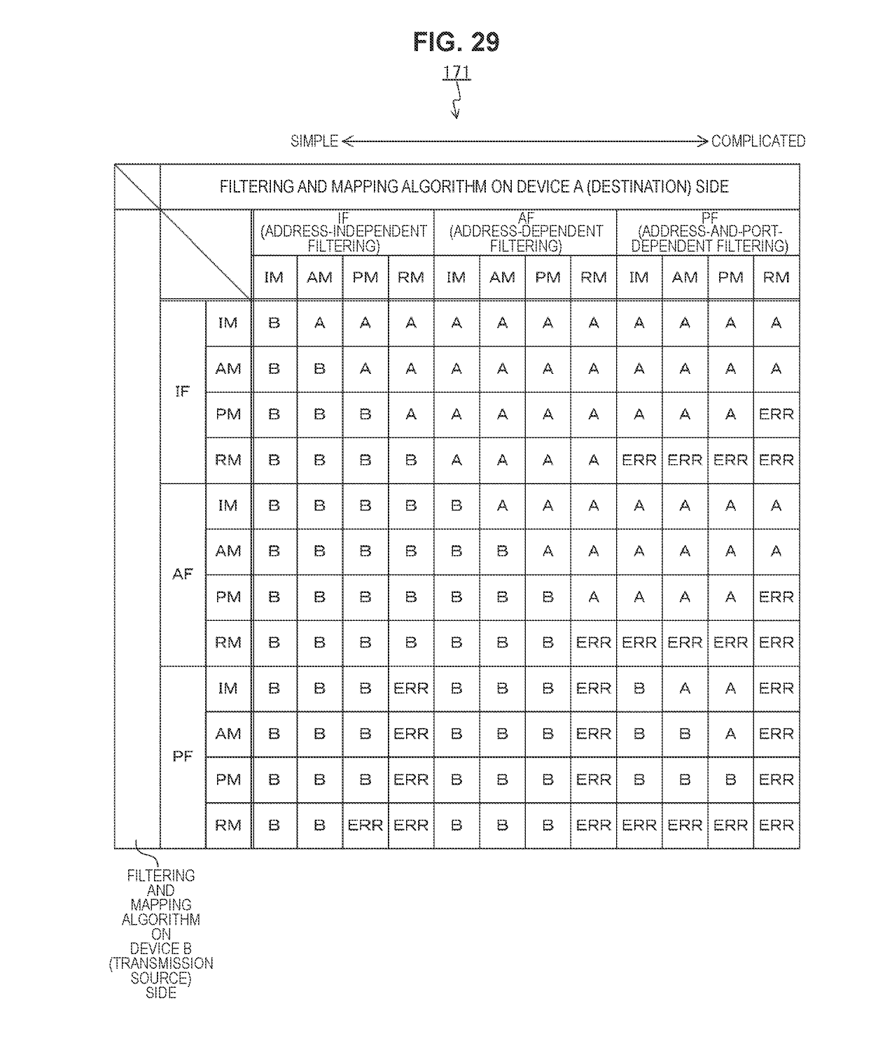

FIG. 29 is a view illustrating one configuration example of the determination table 171 in the second embodiment. This determination table 171 stores a flag for each combination of the transmission source mapping algorithm, the transmission source filtering algorithm, the destination mapping algorithm and the destination filtering algorithm.

In the determination table 171, “IF” stands for the endpoint-independent filtering. “AF” stands for the address-dependent filtering. “PF” stands for the address-and-port-dependent filtering.

In a case where the destination filtering algorithm on the device A side is more complicated than the transmission source filtering algorithm on the device B side, information showing that device A is set as a master is recorded. This is because the filtering algorithm on the device B side is simpler and it is easy to cause a communication packet to pass from device A to device B.

By contrast, in a case where the transmission source filtering algorithm on the device B side is more complicated than the destination filtering algorithm on the device A side, information showing that device B is set as a master is recorded.

Moreover, in a case where the destination filtering algorithm on the device B side and the transmission source filtering algorithm on the device A side are identical, the master is decided on the basis of mapping algorithms.

In a case where the destination filtering algorithm and the transmission source filtering algorithm are identical and the destination mapping algorithm is more complicated than the transmission source mapping algorithm, information showing that device A is set as a master is recorded. This is because the mapping algorithm on the device B side is simpler and it is easier for device A to predict the external port number than device B.

In a case where the destination filtering algorithm and the transmission source filtering algorithm are identical and the destination mapping algorithm is more complicated than the transmission source mapping algorithm, information showing that device B is set as a master is recorded. Moreover, in a case where the destination filtering algorithm and the transmission source filtering algorithm are identical and the destination mapping algorithm and the transmission source mapping algorithm are also identical, information showing that device B is set as a master is recorded.

Also, “ERR” shows that direct communication is difficult. For example, “ERR” is described in a case where the master predicts the external port number assigned by the random mapping. This is because the master is not able to accurately predict the external port number assigned by the random mapping. In this case, for example, the device 100 performs communication with the device 101 via the server 500.

[Operation Example of Device]

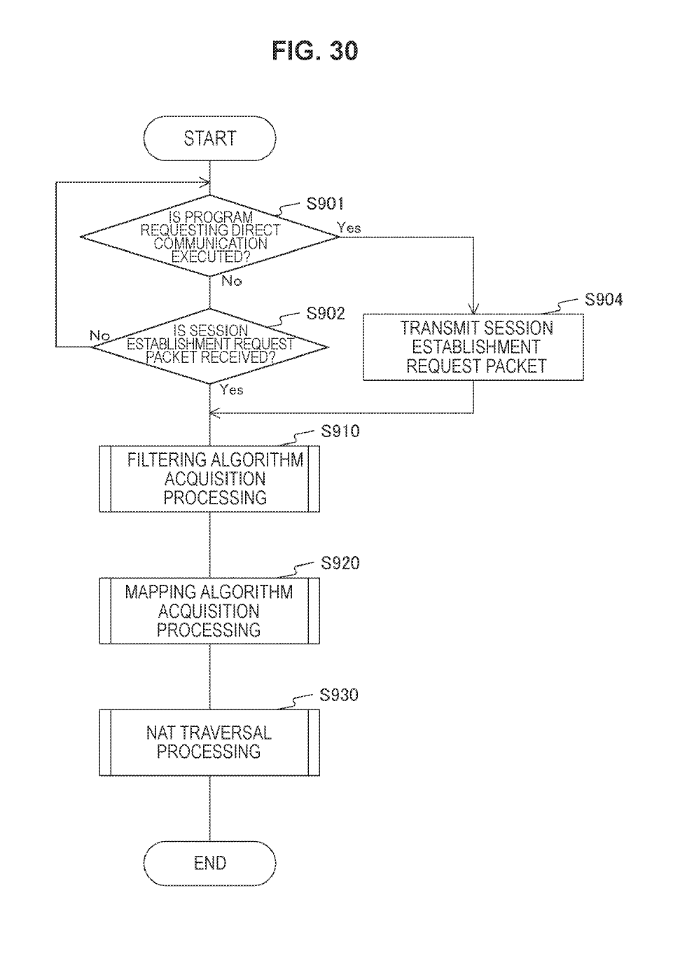

FIG. 30 is a flowchart illustrating one example of the operation of the device 100 in the second embodiment. The operation of the device 100 of the second embodiment is different from the first embodiment in further executing step S910. The operation of the device 101 of the second embodiment is similar to the device 100.

In a case where a session establishment request packet is received (step S902: Yes), or, after step S904, the device 100 performs filtering algorithm acquisition processing to acquire a filtering algorithm (step S910). Further, the device 100 performs mapping algorithm acquisition processing (step S920) and NAT traversal processing (step S930).

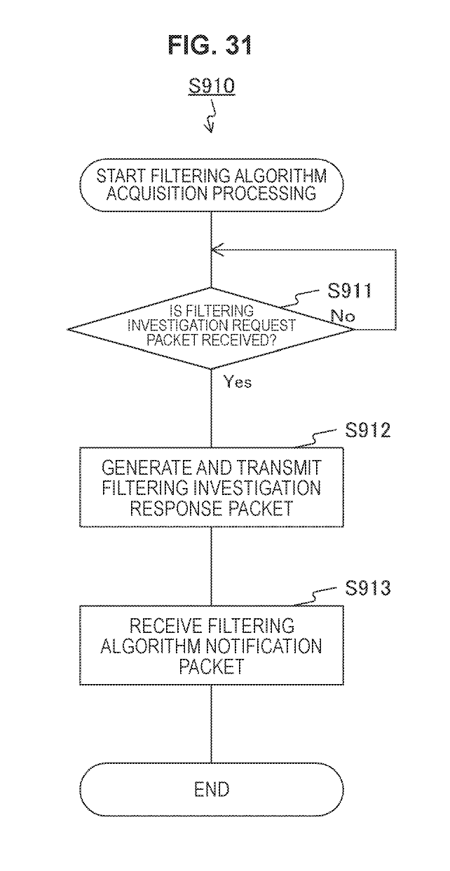

FIG. 31 is a flowchart illustrating one example of filtering algorithm acquisition processing in the second embodiment. The device 100 determines whether to have received a plurality of filtering investigation request packets from the server 500 (step S911). If the filtering investigation request packets are not received (step S911: No), the device 100 returns to step S911.

If the plurality of filtering investigation request packets are received (step S911: Yes), the device 100 generates and transmits filtering investigation response packets according thereto (step S912). Further, the device 100 receives a filtering algorithm notification packet from the server 500 and acquires the filtering algorithms of the transmission source and the destination from the packet (step S913). After step S913, the device 100 finishes the filtering algorithm acquisition processing.

[Operation Example of Server]

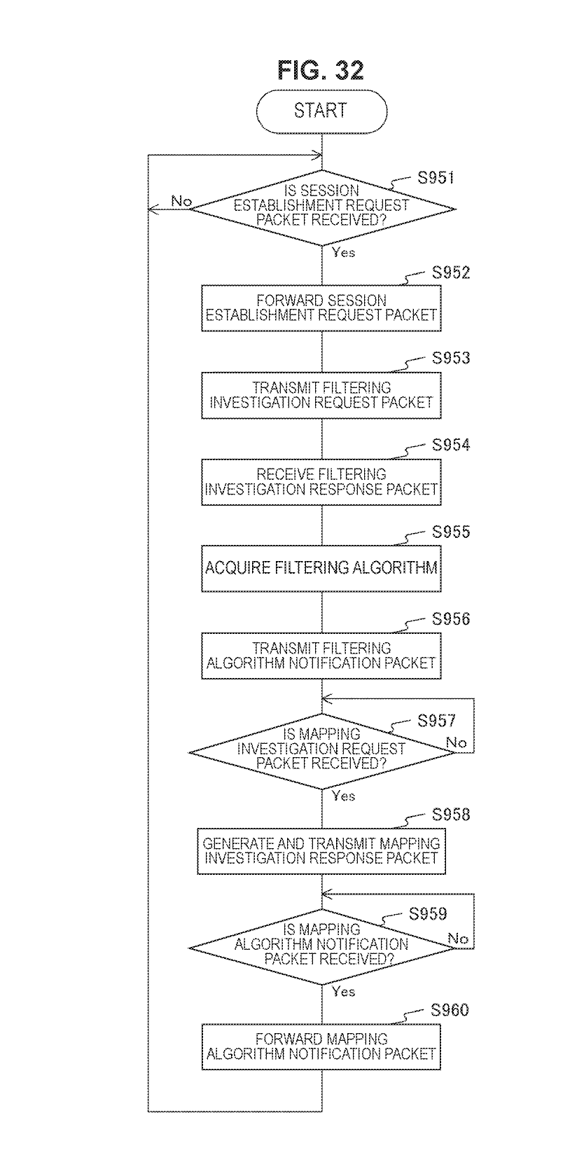

FIG. 32 is a flowchart illustrating one example of operation of the server 500 in the second embodiment. The operation of the server 500 of the second embodiment is different from the first embodiment in further executing steps S953 to S956.

The server 500 forwards a session establishment request packet (step S952) and transmits a plurality of filtering investigation request packets to the transmission source device and the destination device (step S953). The server 500 receives filtering investigation response packets from the transmission source device and the destination device (step S954). The server 500 acquires a transmission source filtering algorithm and a destination filtering algorithm according to the reception state of those response packets (step S955).

Further, the generation of the server 500 generates a filtering algorithm notification packet storing the acquired filtering algorithms and transmits it to the transmission source device and the destination device (step S956). After step S956, the server 500 executes steps S957 to S960.

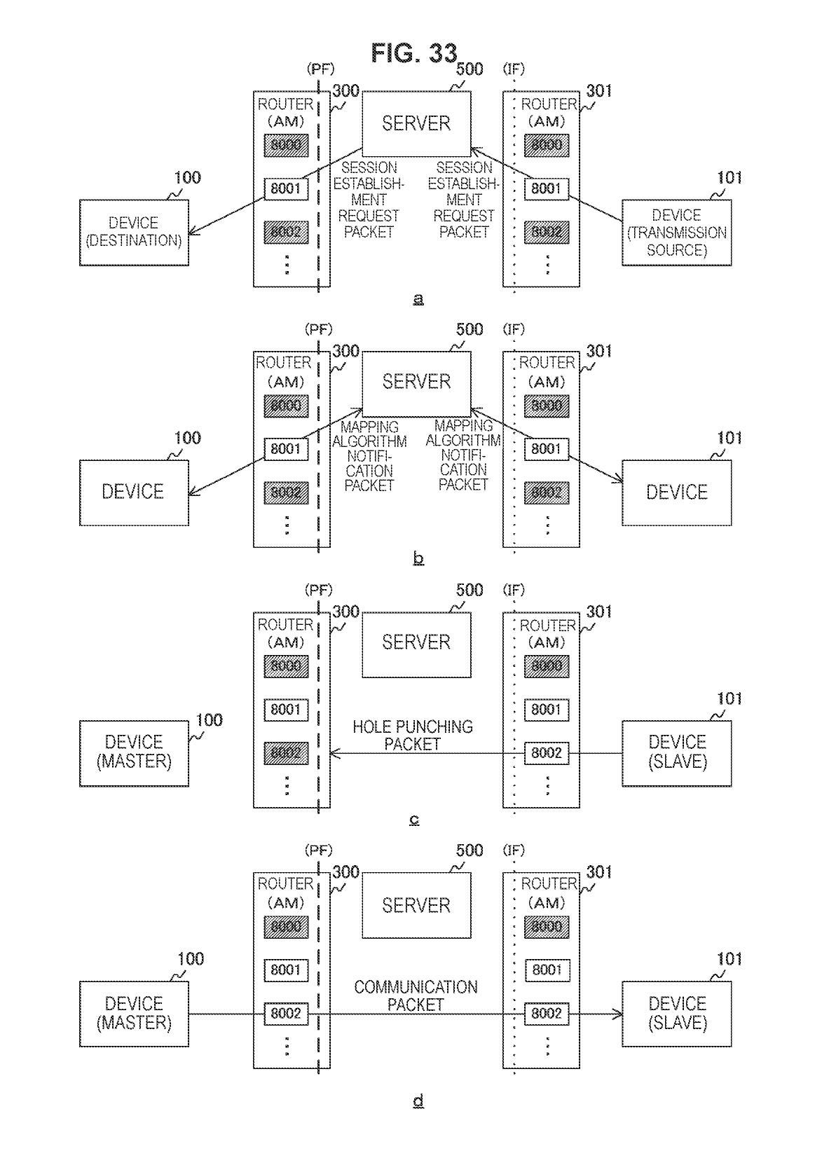

FIG. 33 is a view illustrating one example of the usage state of the external port numbers in the second embodiment. In FIG. 33, “a” shows a view illustrating one example of the usage state of the external port numbers when the device 101 (transmission source) transmits a session establishment request packet to the device 100 (destination). It is assumed that the router 300 registers port number “8001” and the server 500 in association with the device 100 in the address conversion table. Moreover, the router 301 registers port number “8001” and the server 500 in association with the device 101 in the address conversion table.

In FIG. 33, “b” shows a view illustrating one example of the usage state of the external port numbers when a mapping algorithm notification packet is transmitted and received. As compared with “a” in FIG. 33, there is no change in the usage state of the external ports in “b” in FIG. 33.

The devices 100 and 101 acquire the transmission source mapping algorithm, the transmission source filtering algorithm, the destination mapping algorithm and the destination filtering algorithm.

Here, it is assumed that the address-dependent mapping (AM) is acquired as the transmission source mapping algorithm and the destination mapping algorithm. Moreover, it is assumed that the address-and-port-dependent filtering (PF) is acquired as the destination filtering algorithm in the router 300. Further, it is assumed that the endpoint-independent filtering (IF) is acquired as the transmission source filtering algorithm in the router 301.

In this case, since it is easier to cause a communication packet to pass in simple endpoint-independent filtering, the device 100 becomes a master and the device 101 becomes a slave. The device 101 of the slave transmits a hole punching packet to the device 100.

In FIG. 33, “c” shows a view illustrating one example of the usage state of the external port numbers when the hole punching packet is transmitted. Since the destination IP address of the hole punching packet is different from the IP address of the server 500, the router 300 newly assigns external port number “8002” to the device 100.

The device 100 of the master predicts external port number “8002” newly assigned to the device 100, from previous external port number “8001” of the device 100, and transmits a communication packet to the external port number.

In FIG. 33, “d” shows a view illustrating one example of the usage state of the external port numbers when the communication packet is transmitted. In the router 300, since predicted external port number “8002” is released, the communication packet is delivered to the device 100 of the slave.

Here, a configuration is provisionally considered where the transmission source device (101) becomes a master and the destination device (100) operates as a slave, without referring to the determination table 171. In this configuration, the device 100 of the slave transmits a hole punching packet and the external port number of the router 300 is released.

However, the filtering algorithm of the router 300 is the address-and-port-dependent filtering. Therefore, the destination port number of a hole punching packet which the slave transmits directed to the master has to match the transmission source port number of a communication packet which the master transmits. Further, the external port number which the router 300 assigns when the slave transmits the hole punching packet directed to the master has to match the transmission source port of the communication packet which the master transmits. Therefore, the probability of failing in direction communication rises.

By contrast with this, the device 100 or 101 compares the complexity of both filtering algorithms, and predicts the external port number in a router that performs the simpler filtering. Therefore, it is possible to improve the probability of succeeding in the direct communication.

Thus, according to the second embodiment of the present disclosure, since the device 100 or 101 generates the external port number newly assigned in a router of the simpler filtering algorithm, it is possible to improve the probability of succeeding in direct communication.

### 3. Third Embodiment

### Configuration Example of Device

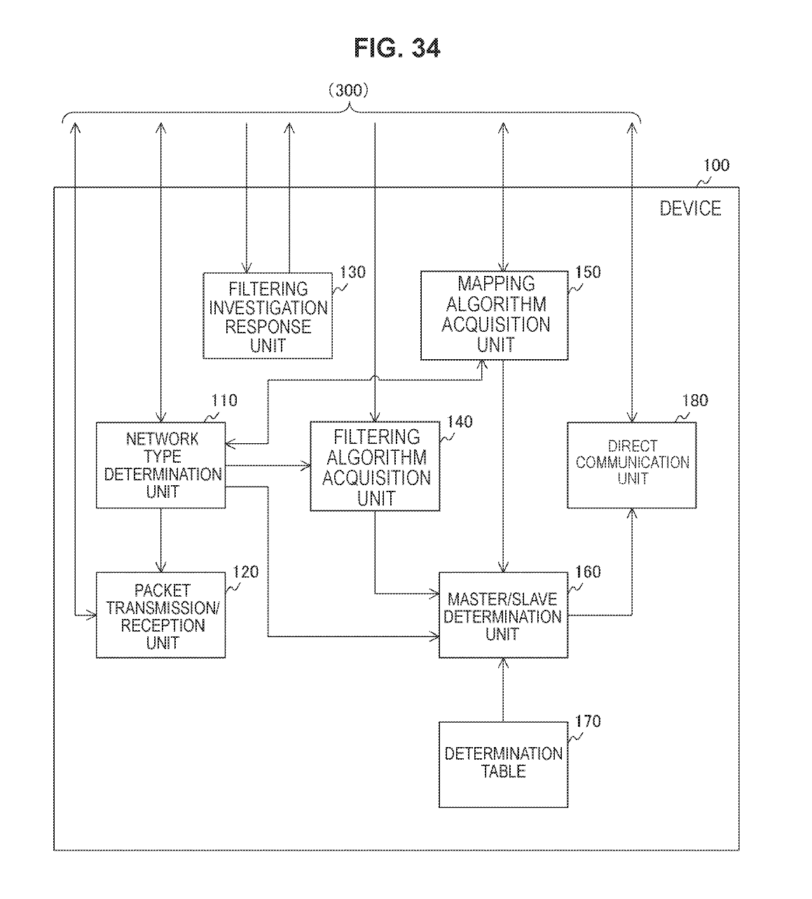

FIG. 34 is a block diagram illustrating one configuration example of the device 100 in the third embodiment. In the second embodiment, the device 100 determined whether to set a master, regardless of the type of a network to which the device 100 is connected. However, there is a case where the determination does not have to be performed depending on the network type. For example, there is a case where the NAT traversal does not have to be performed or the NAT traversal is not possible, and so on. The device 100 of the third embodiment is different from the second embodiment in determining whether to optionally set a master after acquiring the network type.

Specifically, the device 100 of the third embodiment is different from the second embodiment in further including a network type determination unit 110 and a packet transmission/reception unit 120. The configuration of the device 101 in the second embodiment is similar to the device 100.

The network type determination unit 110 determines the type of a network to which the device 100 is directly connected, as a network type. Here, the network type is classified into types T1, T2, T3, T4 and T5.

First, the network type determination unit 110 determines whether the device 101 of the communication target is connected with the same LAN as the device 100. If the device 101 is a device in the same LAN, the network type determination unit 110 determines that the network type is type T1. In the case of this type T1, the devices 100 and 101 can perform direct communication without performing the NAT traversal.

The network type determination unit 110 notifies the determination result about type T1 to the filtering algorithm acquisition unit 140, the mapping algorithm acquisition unit 150, the master/slave determination unit 160 and the packet transmission/reception unit 120. In the case of type T1, the filtering algorithm acquisition unit 140 does not acquire the filtering algorithm and the mapping algorithm acquisition unit 150 does not acquire the mapping algorithm. Moreover, the master/slave determination unit 160 does not determine whether to set the master. This is because the NAT traversal does not have to be performed in type T1. In the case of type T1, the packet transmission/reception unit 120 performs direct communication with the device 101, instead of the direct communication unit 180.

Next, in a case where it is not type T1, the network type determination unit 110 receives a mapping algorithm notification packet from the mapping algorithm acquisition unit 150 and determines whether the device 100 is directly connected with the WAN 400. If the device 100 is directly connected with the WAN 400, the network type determination unit 110 determines that the network type is type T2. In the case of this type T2, since the IP address of the device 100 is not converted, the device 101 does not have to predict the external port number. Since communication surely becomes possible if a communication packet is transmitted from the device 101 to the device 100, the device 100 becomes a slave and the device 101 become a master. Therefore, the device 100 does not have to determine whether to set a master, with reference to the determination table 171.

The network type determination unit 110 notifies the determination result about type T2 to the master/slave determination unit 160. In the case of type T1, the master/slave determination unit 160 determines the device 101 as the master without referring to the determination table 171.

Next, when it is neither type T1 nor T2, the network type determination unit 110 determines whether the highest router of the device 100 and the highest router of the device 101 are identical, on the basis of the mapping algorithm notification packet. Further, in a case where the highest routers are identical, the network type determination unit 110 determines whether the highest routers have a hairpin function.

Here, the hairpin function denotes a function that a router further forwards a packet to LAN side when the packet is transmitted from the LAN side of the router to the external IP address on the WAN side. The hairpin function is also referred to as “NAT loop-back” or “IP loop-back”. In a case where the highest routers are identical, one of the devices 100 and 101 in the LAN has to forward a packet, which is transmitted to the external IP address of the router, to the other in the LAN. Without the hairpin function, this forwarding is not performed and it is not possible to realize the NAT traversal.

In a case where the highest routers are different, the network type determination unit 110 determines that the network type is type T3. In a case where the highest routers are identical and the highest routers have the hairpin function, the network type determination unit 110 determines that the network type is type T4. In a case where the highest routers are identical and the highest routers do not have the hairpin function, the network type determination unit 110 determines that the network type is type T5. Although the NAT traversal is possible in types T3 and T4, since it is not possible to realize the NAT traversal in type T5, it is not possible to perform direct communication.

The network type determination unit 110 notifies the determination result about type T5 to the packet transmission/reception unit 120 and the master/slave determination unit 160.

In the case of type T5, the master/slave determination unit 160 does not determine whether to set a master. This is because the NAT traversal is not possible as described above.

In the case of type T5, the packet transmission/reception unit 120 performs communication with the device 101 through the server 500. In this case, for example, the server 500 relays data by the use of TURN (Traversal Using Relay NAT). Here, the server 500 may relay data by the use of a unique protocol.

[Configuration Example of Network Type Determination Unit]

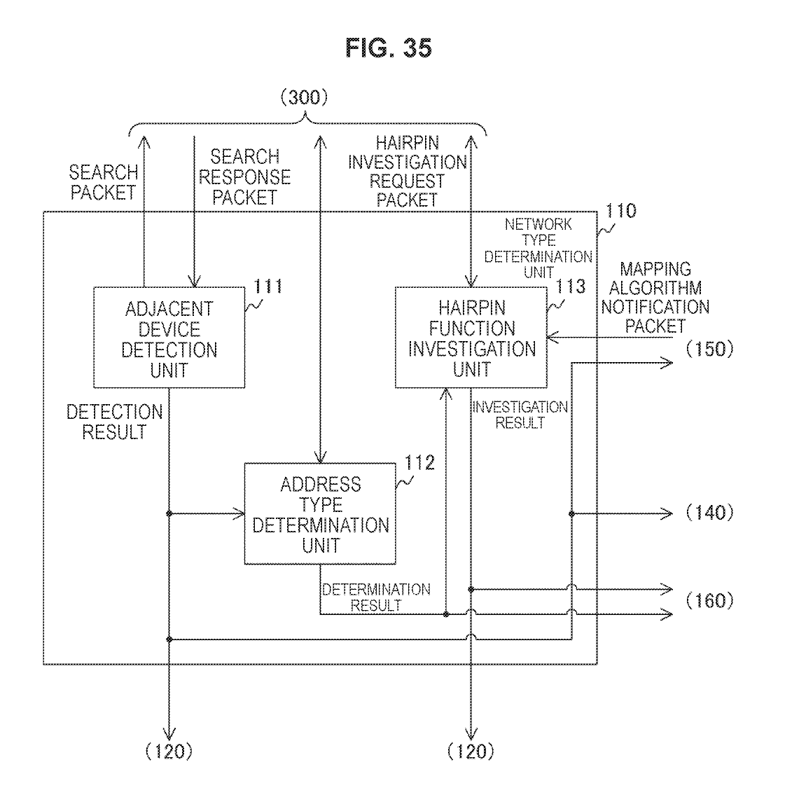

FIG. 35 is a block diagram illustrating one configuration example of the network type determination unit 110 in the third embodiment. This network type determination unit 110 includes an adjacent device detection unit 111, an address type determination unit 112 and a hairpin function investigation unit 113.

The adjacent device detection unit 111 determines whether the device 101 of the communication target is a device connected with the same LAN as the device 100 (hereafter referred to as “adjacent device”). The adjacent device detection unit 111 broadcasts a packet that requests the notification of information (such as the device name and the user name) to specify the device, as a search packet, in the LAN. The search packet is transmitted using, for example, SSDP (Simple Service Discovery Protocol). Here, the search packet may be defined using a unique protocol.

The adjacent device detection unit 111 receives a search response packet for the search packet and determines whether a device notified by the packet is the device 101 of the communication target. If the search response packet is a packet from the device 101 of the communication target, the adjacent device detection unit 111 detects an adjacent device. The adjacent device detection unit 111 notifies the detection result (i.e., the determination result as to whether it is type T1) to the filtering algorithm acquisition unit 140, the mapping algorithm acquisition unit 150, the master/slave determination unit 160 and the packet transmission/reception unit 120. Moreover, the adjacent device detection unit 111 notifies the detection result to the address type determination unit 112. Here, in the case of detecting the adjacent device, the adjacent device detection unit 111 notifies the internal IP address and the internal port number to the packet transmission/reception unit 120.

The address type determination unit 112 determines whether the IP address of the device 101 is the internal address. In a case where the adjacent device is not detected, the address type determination unit 112 acquires the IP address of the device 100 by executing the “ipconfig” command or the like. The address type determination unit 112 determines whether the acquired IP address is the global IP address. In a case where the IP address is the private IP address, the address type determination unit 112 determines that the IP address of the device 100 is the internal IP address.

Meanwhile, in a case where the IP address is the global IP address, the address type determination unit 112 acquires the external IP address of the device 100, which is acquired by the server 500, with reference to the mapping algorithm notification packet generated by the device 100. Depending on whether the external IP address matches the global IP address acquired by the address type determination unit 112, the address type determination unit 112 determines whether the IP address of the device 100 is converted by the router. In a case where the IP address conversion is not performed (i.e., in a case where they are matched), the address type determination unit 112 determines that the IP address of the device 100 is the external IP address (in other words, it is directly connected with the WAN). The address type determination unit 112 notifies the determination result as to whether it is the external IP address (i.e., the determination result as to whether it is type T2), to the master/slave determination unit 160 and the hairpin function investigation unit 113.

The hairpin function investigation unit 113 investigates whether the highest router has a hairpin function. In a case where the IP address of the device 100 is the internal IP address, this hairpin function investigation unit 113 determines whether the highest routers are identical, on the basis of the mapping algorithm notification packet.

Specifically, the hairpin function investigation unit 113 acquires the transmission source IP address from a mapping algorithm notification packet of the device 100. This transmission source IP address is the IP address of the transmission source of the mapping investigation request packet received by the server 500 and corresponds to the IP address in the highest router of the device 100. Moreover, the hairpin function investigation unit 113 acquires the transmission source IP address from a mapping algorithm notification packet of the device 101. This transmission source IP address corresponds to the IP address of the highest router of the device 101. If these transmission source IP addresses are matched, it is determined that the highest routers are identical.

If the highest routers are identical, the hairpin function investigation unit 113 generates the external port number different from the external port number of the device 100, which is acquired from the mapping algorithm notification packet. The hairpin function investigation unit 113 transmits a packet directed to the destination including that external port number and the external IP address assigned to the device 100, as a hairpin investigation request packet. If the router 300 has the hairpin function, this hairpin investigation request packet is forwarded to the device 100 (i.e., IP loop-back).

The hairpin function investigation unit 113 determines whether to have received the hairpin investigation request packet. In the case of receiving it, the hairpin function investigation unit 113 determines that the highest router has the hairpin function. By contrast, in the case of not receiving it, the hairpin function investigation unit 113 determines that the highest router does not have the hairpin function. The hairpin function investigation unit 113 notifies the investigation result (in other words, the determination result as to whether it is type T5) to the packet transmission/reception unit 120 and the master/slave determination unit 160.

Here, although the hairpin function investigation unit 113 investigates the hairpin function by transmitting and receiving the hairpin investigation request packet, it is not limited to this configuration. For example, the hairpin function may be investigated using the STUN protocol.

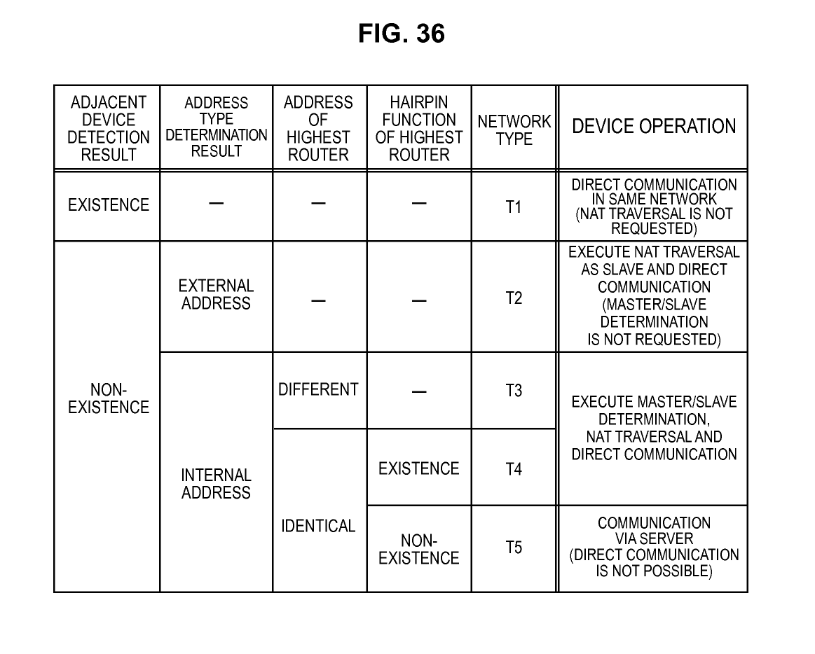

FIG. 36 is a view illustrating one example of operation of the device in the third embodiment. In a case where the adjacent device is detected, it is determined that the network type is type T1. In this case, the NAT traversal is not requested, and the device 100 performs direct communication with the device 101 in the same network.

In a case where the adjacent device is not detected, it is determined whether the IP address of the device 100 is the internal IP address. If it is the external IP address, it is determined that the network type is type T2. In this case, the determination as to whether to set the master is not requested, and the device 100 executes NAT traversal processing as a slave and performs direct communication.

If the IP address of the device 100 is the internal IP address, it is determined whether the highest routers are identical. If the highest routers are different, it is determined that the network type is type T3.

If the highest routers are identical, it is investigated whether the highest router has the hairpin function. In a case where the highest router has the hairpin function, it is determined that the network type is type T4. Meanwhile, in a case where the highest router does not have the hairpin function, it is determined that the network type is type T5.

In a case where it is type T3 or T4, the device 100 determines whether to set the master, performs NAT traversal processing and performs direct communication. Meanwhile, in a case where it is type T5, since the direct communication is not possible, the device 100 performs communication with the device 101 through the server 500.

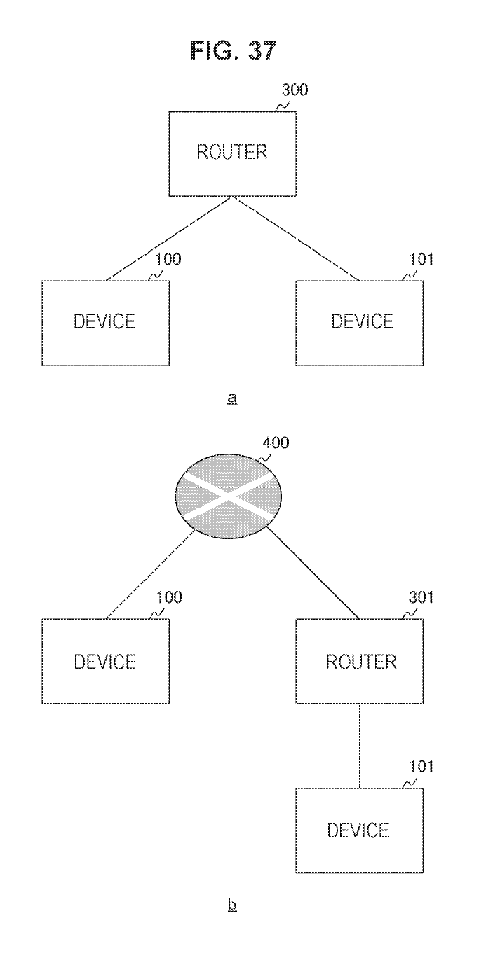

FIG. 37 is a view illustrating one example of network types T1 and T2 in the third embodiment. In FIG. 37, “a” shows a view illustrating one example of network type T1. The devices 100 and 101 are connected with the same router 300, and denote devices in the same LAN. In this case, the devices can perform direct communication with each other without performing the NAT traversal.

In FIG. 37, “b” shows a view illustrating one example of network type T2. The device 100 is directly connected with the WAN 400, and the device 101 is connected with the WAN 400 through the router 301. In this case, the device 100 becomes the slave and performs the NAT traversal processing.

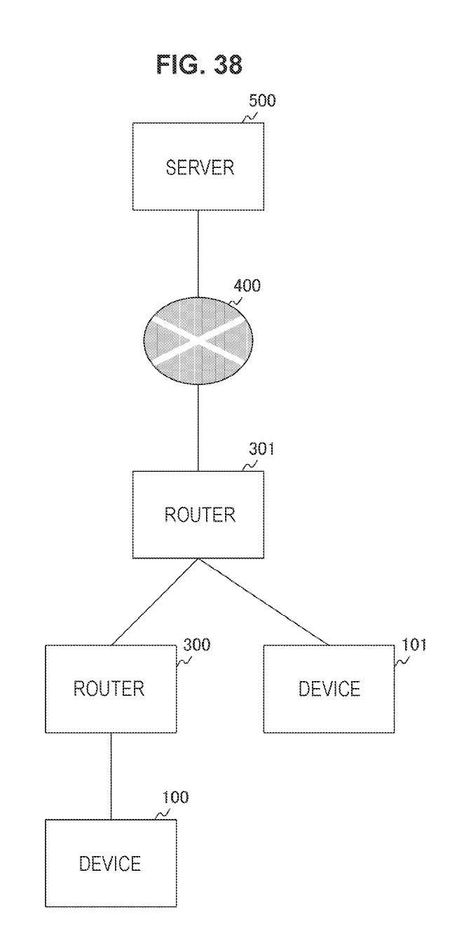

FIG. 38 is a view illustrating one example of network types T4 and T5 in the third embodiment. The device 100 is connected with the router 301 through the router 300, and the device 101 is directly connected with the router 301. That is, the highest router of the device 100 and the highest router of the device 101 are identical. In this case, in direct communication between the devices 100 and 101, the highest router 301 has to forward a packet, which is directed from the device 100 in the LAN to the outside, to the device 101 in the LAN (i.e., IP loop-back). Therefore, in a case where the router 301 has the hairpin function, the NAT traversal is realized. Here, network type T3 is similar to the configuration illustrated in FIG. 1.

[Operation Example of Device]

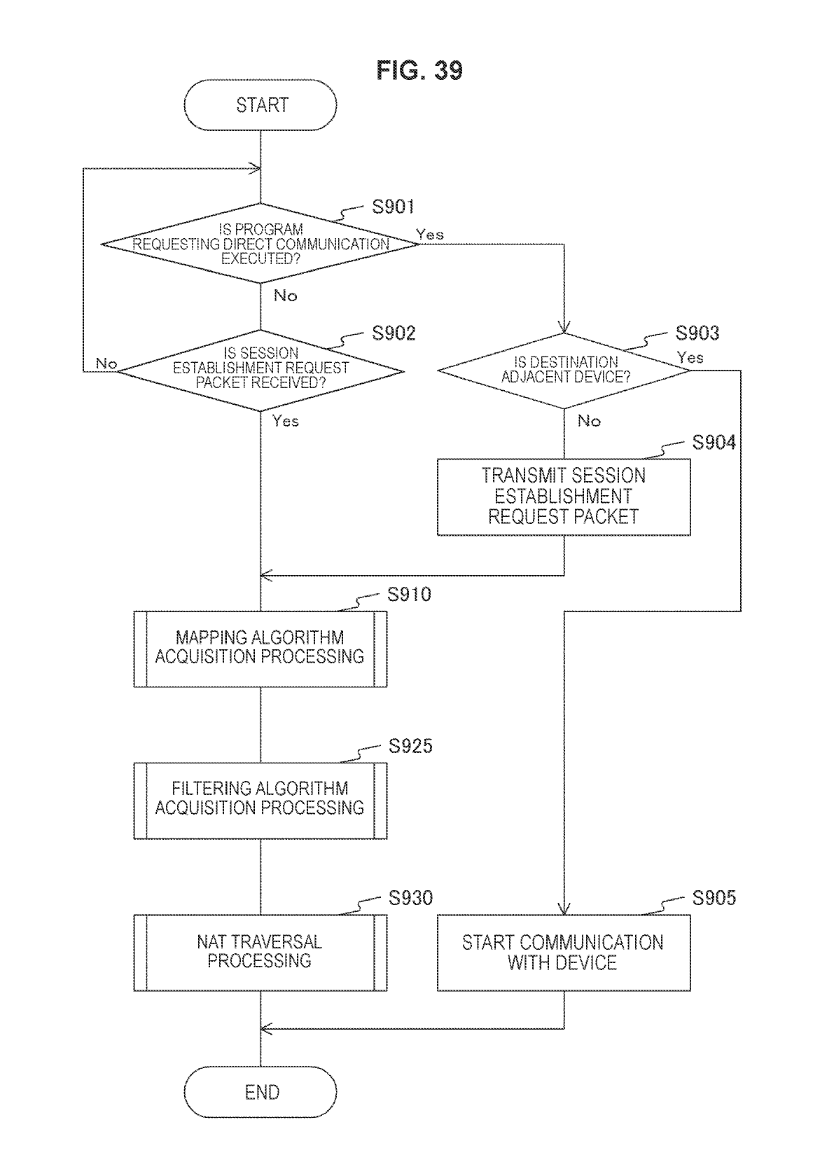

FIG. 39 is a flowchart illustrating one example of operation of the device 100 in the third embodiment. The operation of the device 100 of the third embodiment is different from the second embodiment in further executing steps S903 and S905. The operation of the device 101 of the third embodiment is similar to the device 100.

When a program requesting direct communication is executed (step S901: Yes), the device 100 determines whether the destination device 101 is a device in the same LAN (adjacent device) (step S903).

If it is not the adjacent device (step S903: No), the device 100 transmits a session establishment request packet to the server 500 (step S904). Meanwhile, if it is the adjacent device (step S903: Yes), the device 100 starts communication with the device 101 not via the server 500 (step S905). After step S905, the device 100 finishes the operation.

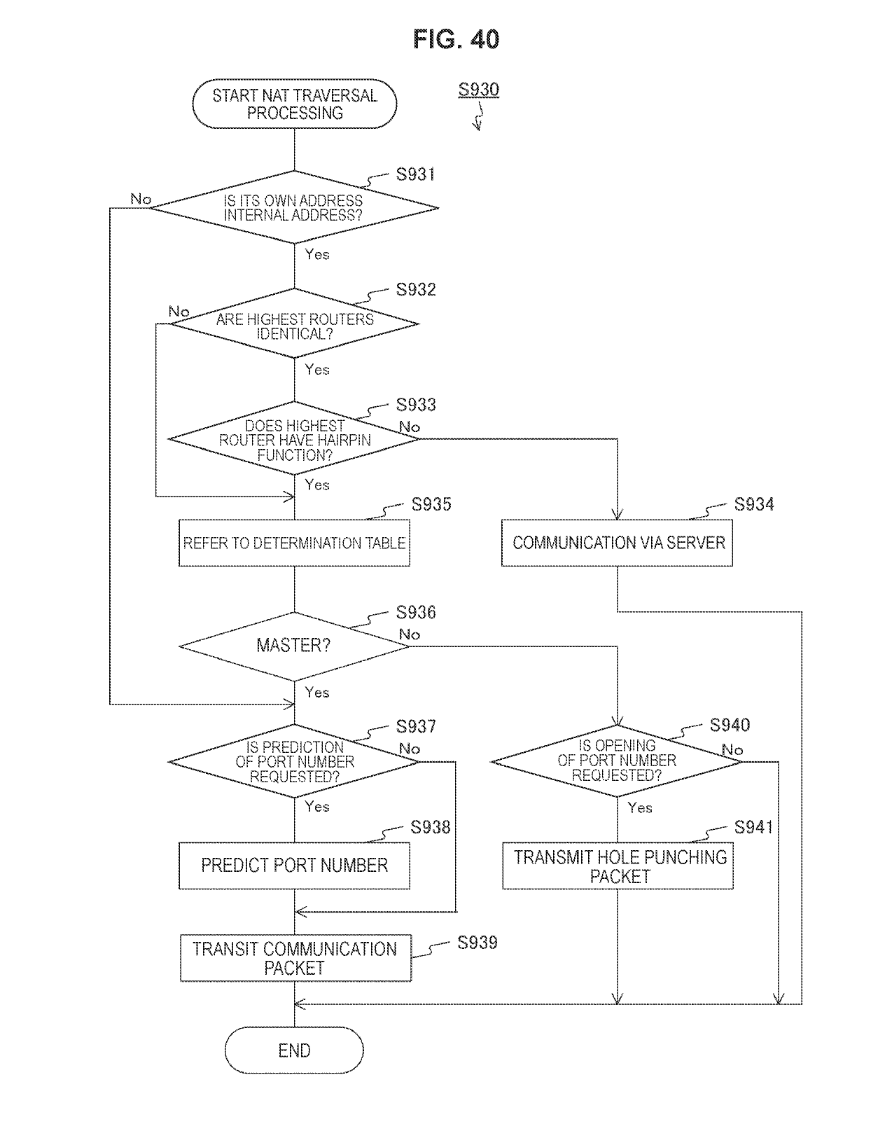

FIG. 40 is a flowchart illustrating one example of NAT traversal processing of the third embodiment. The NAT traversal processing of the third embodiment is different from the second embodiment in further executing steps S931, S932, S933 and S934.

The device 100 determines whether the address of the device 100 is the internal IP address (step S931). In a case where it is the internal IP address (step S931: Yes), the device 100 determines whether the highest routers of the devices 100 and 101 are identical (step S932). In a case where the highest routers are identical (step S932: Yes), the device 100 determines whether the highest router has the hairpin function (step S933).

In a case where the highest routers are different (step S932: No) or in a case where the highest router has the hairpin function (step S933: Yes), the device 100 refers to the determination table 170 (step S935).

The device 100 determines whether to set the device 100 as the master, according to a flag (step S936). In a case where the device 100 is set as the master (step S936: Yes) or in a case where its own address is the external IP address (step S931: No), the device 100 executes steps S937 to S939.

In a case where the highest router does not have the hairpin function (step S933: No), the device 100 performs communication via the server 500 (step S934). After step S934, the device 100 finishes the operation.

Also, in the third embodiment, in step S940, for example, in a case where the endpoint-independent mapping is provided on the slave side and the endpoint-independent filtering is provided on the slave side, it is determined that the opening of the port numbers is not requested.

Thus, according to the third embodiment of the present disclosure, whether to set the device 100 as a master is optionally determined on the basis of the network type, and therefore it is possible to perform direct communication in various network configurations.

Note that the aforementioned embodiments are shown as examples of embodying the present technology, and there is a correspondence between a matter in the embodiments and a matter specifying the present technology in the scope of claims. Likewise, there is a correspondence between a matter specifying the present technology in the scope of claims and a matter having the same name in the embodiments of the present technology. The present technology, however, is not limited to the embodiments, and can be embodied by making various modifications to the embodiments without departing from the gist of the technology.

Further, the procedures described in each of the aforementioned embodiments may be understood as a method including a series of these procedures, and may be understood as a program for causing a computer to execute the series of these procedures or a recording medium storing the program therein. As the recording medium, for example, a CD (a Compact Disc), an MD (a MiniDisc), a DVD (a Digital Versatile Disc), a memory card, or Blu-ray Disc (registered trademark) can be used.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) A communication apparatus including:

a transmission source mapping algorithm acquisition unit configured to acquire an algorithm that assigns an external address and an external port number to an internal address and an internal port number of a transmission source, as a transmission source mapping algorithm;

a destination mapping algorithm acquisition unit configured to acquire an algorithm that assigns an external address and an external port number to an internal address and an internal port number of a destination, as a destination mapping algorithm; and

a generation unit configured to generate, on the basis of the transmission source mapping algorithm, an external port number newly assigned to the internal address and the internal port number of the destination in a case where the transmission source mapping algorithm is more complicated than the destination mapping algorithm.

(2) The communication apparatus according to (1),

wherein the transmission source mapping algorithm acquisition unit includes
a mapping investigation request packet transmission unit configured to transmit a plurality of packets that request a notification of the external address and the external port number assigned to the internal address and the internal port number of the transmission source, as mapping investigation request packets, to a plurality of different destinations, and
a mapping investigation response packet reception unit configured to receive mapping investigation response packets with respect to the mapping investigation request packets and acquire the transmission source mapping algorithm based on the external address and the external port number notified by the mapping investigation response packets.
   (3) The communication apparatus according to (1) OR (2), further including:

a transmission source filtering algorithm acquisition unit configured to acquire an algorithm that determines whether to cause a packet directed to the internal address and the internal port number of the transmission source to pass, as a transmission source filtering algorithm; and

a destination filtering algorithm acquisition unit configured to acquire an algorithm that determines whether to cause a packet directed to the internal address and the internal port number of the destination to pass, as a destination filtering algorithm,

wherein the generation unit generates, on the basis of the transmission source mapping algorithm, the external port number in a case where the transmission source filtering algorithm is more complicated than the destination filtering algorithm or in a case where the transmission source filtering algorithm and the destination filtering algorithm are identical and the transmission source mapping algorithm is more complicated than the destination mapping algorithm.

(4) The communication apparatus according to any one of (1) to (3), further including:

a table configured to store a flag that shows whether the transmission source mapping algorithm is more complicated than the destination mapping algorithm, for each combination of the transmission source mapping algorithm and the destination mapping algorithm; and

an algorithm determination unit configured to determine whether the transmission source mapping algorithm is more complicated than the destination mapping algorithm, based on the flag corresponding to a combination of the transmission source mapping algorithm and the destination mapping algorithm,

wherein the generation unit generates the external port number in a case where the algorithm determination unit determines that the transmission source mapping algorithm is more complicated than the destination mapping algorithm.

(5) The communication apparatus according to (4), further including

a same-intra-network address determination unit configured to determine whether the internal address of the transmission source and the internal address of the destination are addresses in a same local area network,

wherein the algorithm determination unit determines whether the transmission source mapping algorithm is more complicated than the destination mapping algorithm, in a case where the internal address of the transmission source and the internal address of the destination are addresses in different local area networks.

(6) The communication apparatus according to (4) or (5), further including

an address type determination unit configured to determine whether an assigned address is the internal address,

wherein the algorithm determination unit determines whether the transmission source mapping algorithm is more complicated than the destination mapping algorithm, in a case where the assigned address is the internal address.

(7) The communication apparatus according to any one of (4) to (6) further including

a conversion device determination unit configured to determine whether a transmission source conversion device that executes the transmission source mapping algorithm and converts an internal address and an internal port number into an external address and an external port number, is identical with a determination conversion device that executes the destination mapping algorithm and converts an internal address and an internal port number into an external address and an external port number,

wherein the algorithm determination unit determines whether the destination mapping algorithm is more complicated than the transmission source mapping algorithm, in a case where the transmission source conversion device and the destination conversion device are different.

(8) The communication apparatus according to (7), further including

a loop-back determination unit configured to determine whether the transmission source conversion device performs loop-back processing that forwards a packet from an external address assigned to the internal address of the transmission source to an external address corresponding to the internal address of the transmission source,

wherein the algorithm determination unit determines whether the transmission source mapping algorithm is more complicated than the destination mapping algorithm, in a case where the transmission source conversion device and the destination conversion device are different or in a case where the transmission source conversion device and the destination conversion device are identical and the transmission source conversion device performs the loop-back processing.

(9) The communication apparatus according to any one of (1) to (8), further including

a hole punching packet transmission unit configured to transmit a packet to the external address and the external port number assigned to the internal address and the internal port number of the destination, as a hole punching packet, in a case where the transmission source mapping algorithm is not more complicated than the destination mapping algorithm.

(10) The communication apparatus according to (9), wherein the hole punching packet transmission unit generates the external port number and transmits the hole punching packet to the external port number and the external address in a case where the transmission source mapping algorithm is a specific algorithm.
(11) The communication apparatus according to any one of (1) to (10), further including

a packet transmission unit configured to transmit a packet to a generated external port number when the external port number is generated.

(12) A communication system including:

a server configured to transmit an algorithm that assigns an external address and an external port number to an internal address and an internal port number of a destination, as a destination mapping algorithm; and

a communication apparatus including a transmission source mapping algorithm acquisition unit configured to acquire an algorithm that assigns an external address and an external port number to an internal address and an internal port number of a transmission source, as a transmission source mapping algorithm, a destination mapping algorithm reception unit configured to receive the destination mapping algorithm, and a generation unit configured to generate, on the basis of the transmission source mapping algorithm, an external port number newly assigned to the internal address and the internal port number of the destination, in a case where the transmission source mapping algorithm is more complicated than the destination mapping algorithm.

(13) The communication system according to (12),

wherein the server includes
a destination mapping algorithm transmission unit configured to transmit the destination mapping algorithm,
a transmission source filtering algorithm transmission unit configured to acquire an algorithm that determines whether to cause a packet directed to the internal address and the internal port number of the transmission source to pass, and transmit the algorithm as a transmission source filtering algorithm, and
a filtering algorithm transmission unit configured to acquire an algorithm that determines whether to cause a packet directed to the internal address and the internal port number of the destination to pass, and transmit the algorithm as a destination filtering algorithm,

wherein the communication apparatus further includes:
a transmission source filtering algorithm reception unit configured to receive the transmission source filtering algorithm, and
a destination filtering algorithm reception unit configured to receive the destination filtering algorithm, and

wherein the generation unit generates the newly assigned external port number in a case where the transmission source filtering algorithm is more complicated than the destination filtering algorithm or in a case where the transmission source filtering algorithm and the destination filtering algorithm are identical and the transmission source mapping algorithm is more complicated than the destination mapping algorithm.

(14) The communication system according to (13),

wherein the transmission source filtering algorithm transmission unit and the destination filtering algorithm transmission unit include
a filtering investigation request packet transmission unit configured to transmit a plurality of packets that request a reply to the external addresses and the external port numbers assigned to the internal addresses and internal port numbers of the transmission source and the destination, as filtering investigation request packets, from different external addresses and external port numbers in the server, and
a filtering algorithm acquisition unit configured to acquire and transmit the transmission source filtering algorithm and the destination filtering algorithm, based on whether there is a reply to each of the filtering investigation request packets.
   (15) A control method of a communication apparatus, the method including:

acquiring, by a transmission source mapping algorithm acquisition unit, an algorithm that assigns an external address and an external port number to an internal address and an internal port number of a transmission source, as a the transmission source mapping algorithm;

acquiring, by a destination mapping acquisition unit, an algorithm that assigns an external address and an external port number to an internal address and an internal port number of a destination, as an destination mapping algorithm; and

generating, by a generation unit, on the basis of the transmission source mapping algorithm, an external port number newly assigned to the internal address and the internal port number of the destination, in a case where the transmission source mapping algorithm is more complicated than the destination mapping algorithm.

(16) A program for causing a computer to execute:

acquiring, by a transmission source mapping algorithm acquisition unit, an algorithm that assigns an external address and an external port number to an internal address and an internal port number of a transmission source, as a the transmission source mapping algorithm;

acquiring, by a destination mapping acquisition unit, an algorithm that assigns an external address and an external port number to an internal address and an internal port number of a destination, as an destination mapping algorithm; and

generating, by a generation unit, on the basis of the transmission source mapping algorithm, an external port number newly assigned to the internal address and the internal port number of the destination, in a case where the transmission source mapping algorithm is more complicated than the destination mapping algorithm.

What is claimed is:

1. A communication apparatus comprising:
a transmission source mapping algorithm acquisition unit configured to acquire an algorithm that assigns an external address and an external port number to an internal address and an internal port number of a transmission source, as a transmission source mapping algorithm;
a destination mapping algorithm acquisition unit configured to acquire an algorithm that assigns an external address and an external port number to an internal address and an internal port number of a destination, as a destination mapping algorithm; and
a generation unit configured to generate an external port number newly assigned to the internal address and the internal port number of the destination in a case where the transmission source mapping algorithm is more complicated than the destination mapping algorithm.

2. The communication apparatus according to claim 1,
wherein the transmission source mapping algorithm acquisition unit includes
a mapping investigation request packet transmission unit configured to transmit a plurality of packets that request a notification of the external address and the external port number assigned to the internal address and the internal port number of the transmission source, as mapping investigation request packets, to a plurality of different destinations, and
a mapping investigation response packet reception unit configured to receive mapping investigation response packets with respect to the mapping investigation request packets and acquire the transmission source mapping algorithm based on the external address and the external port number notified by the mapping investigation response packets.

3. The communication apparatus according to claim 1, further comprising:
a transmission source filtering algorithm acquisition unit configured to acquire an algorithm that determines whether to cause a packet directed to the internal address and the internal port number of the transmission source to pass, as a transmission source filtering algorithm; and
a destination filtering algorithm acquisition unit configured to acquire an algorithm that determines whether to cause a packet directed to the internal address and the internal port number of the destination to pass, as a destination filtering algorithm,
wherein the generation unit generates the external port number in a case where the transmission source filtering algorithm is more complicated than the destination filtering algorithm or in a case where the transmission source filtering algorithm and the destination filtering algorithm are identical and the transmission source mapping algorithm is more complicated than the destination mapping algorithm.

4. The communication apparatus according to claim 1, further comprising:
a table configured to store a flag that shows whether the transmission source mapping algorithm is more complicated than the destination mapping algorithm, for each combination of the transmission source mapping algorithm and the destination mapping algorithm; and
an algorithm determination unit configured to determine whether the transmission source mapping algorithm is more complicated than the destination mapping algorithm, based on the flag corresponding to a combination of the transmission source mapping algorithm and the destination mapping algorithm,
wherein the generation unit generates the external port number in a case where the algorithm determination unit determines that the transmission source mapping algorithm is more complicated than the destination mapping algorithm.

5. The communication apparatus according to claim 4, further comprising
a same-intra-network address determination unit configured to determine whether the internal address of the transmission source and the internal address of the destination are addresses in a same local area network,
wherein the algorithm determination unit determines whether the transmission source mapping algorithm is more complicated than the destination mapping algorithm, in a case where the internal address of the transmission source and the internal address of the destination are addresses in different local area networks.

6. The communication apparatus according to claim 4, further comprising
an address type determination unit configured to determine whether an assigned address is the internal address,
wherein the algorithm determination unit determines whether the transmission source mapping algorithm is more complicated than the destination mapping algorithm, in a case where the assigned address is the internal address.

7. The communication apparatus according to claim 4, further comprising
a conversion device determination unit configured to determine whether a transmission source conversion device that executes the transmission source mapping algorithm and converts an internal address and an internal port number into an external address and an external port number, is identical with a determination conversion device that executes the destination mapping algorithm and converts an internal address and an internal port number into an external address and an external port number,
wherein the algorithm determination unit determines whether the destination mapping algorithm is more complicated than the transmission source mapping algorithm, in a case where the transmission source conversion device and the destination conversion device are different.

8. The communication apparatus according to claim 7, further comprising
a loop-back determination unit configured to determine whether the transmission source conversion device performs loop-back processing that forwards a packet from an external address assigned to the internal address of the transmission source to an external address corresponding to the internal address of the transmission source,
wherein the algorithm determination unit determines whether the transmission source mapping algorithm is more complicated than the destination mapping algorithm, in a case where the transmission source conversion device and the destination conversion device are different or in a case where the transmission source conversion device and the destination conversion device are identical and the transmission source conversion device performs the loop-back processing.

9. The communication apparatus according to claim 1, further comprising
a hole punching packet transmission unit configured to transmit a packet to the external address and the external port number assigned to the internal address and the internal port number of the destination, as a hole punching packet, in a case where the transmission source mapping algorithm is not more complicated than the destination mapping algorithm.

10. The communication apparatus according to claim 9, wherein the hole punching packet transmission unit generates the external port number and transmits the hole punching packet to the external port number and the external address in a case where the transmission source mapping algorithm is a specific algorithm.

11. The communication apparatus according to claim 1, further comprising
a packet transmission unit configured to transmit a packet to a generated external port number when the external port number is generated.

12. A communication system comprising:
a server configured to transmit an algorithm that assigns an external address and an external port number to an internal address and an internal port number of a destination, as a destination mapping algorithm; and
a communication apparatus including a transmission source mapping algorithm acquisition unit configured to acquire an algorithm that assigns an external address and an external port number to an internal address and an internal port number of a transmission source, as a transmission source mapping algorithm, a destination mapping algorithm reception unit configured to receive the destination mapping algorithm, and a generation unit configured to generate an external port number newly assigned to the internal address and the internal port number of the destination, in a case where the transmission source mapping algorithm is more complicated than the destination mapping algorithm.

13. The communication system according to claim 12,
wherein the server includes
a destination mapping algorithm transmission unit configured to transmit the destination mapping algorithm,
a transmission source filtering algorithm transmission unit configured to acquire an algorithm that determines whether to cause a packet directed to the internal address and the internal port number of the transmission source to pass, and transmit the algorithm as a transmission source filtering algorithm, and
a filtering algorithm transmission unit configured to acquire an algorithm that determines whether to cause a packet directed to the internal address and the internal port number of the destination to pass, and transmit the algorithm as a destination filtering algorithm,
wherein the communication apparatus further includes:
a transmission source filtering algorithm reception unit configured to receive the transmission source filtering algorithm, and
a destination filtering algorithm reception unit configured to receive the destination filtering algorithm, and
wherein the generation unit generates the newly assigned external port number in a case where the transmission source filtering algorithm is more complicated than the destination filtering algorithm or in a case where the transmission source filtering algorithm and the destination filtering algorithm are identical and the transmission source mapping algorithm is more complicated than the destination mapping algorithm.

14. The communication system according to claim 13,
wherein the transmission source filtering algorithm transmission unit and the destination filtering algorithm transmission unit include
a filtering investigation request packet transmission unit configured to transmit a plurality of packets that request a reply to the external addresses and the external port numbers assigned to the internal addresses and internal port numbers of the transmission source and the destination, as filtering investigation request packets, from different external addresses and external port numbers in the server, and
a filtering algorithm acquisition unit configured to acquire and transmit the transmission source filtering algorithm and the destination filtering algorithm, based on whether there is a reply to each of the filtering investigation request packets.

15. A control method of a communication apparatus, the method comprising:
acquiring, by a transmission source mapping algorithm acquisition unit, an algorithm that assigns an external address and an external port number to an internal address and an internal port number of a transmission source, as a the transmission source mapping algorithm;
acquiring, by a destination mapping acquisition unit, an algorithm that assigns an external address and an external port number to an internal address and an internal port number of a destination, as an destination mapping algorithm; and
generating, by a generation unit, an external port number newly assigned to the internal address and the internal port number of the destination, in a case where the transmission source mapping algorithm is more complicated than the destination mapping algorithm.

16. A program for causing a computer to execute:
acquiring, by a transmission source mapping algorithm acquisition unit, an algorithm that assigns an external address and an external port number to an internal address and an internal port number of a transmission source, as a the transmission source mapping algorithm;
acquiring, by a destination mapping acquisition unit, an algorithm that assigns an external address and an external port number to an internal address and an internal port number of a destination, as an destination mapping algorithm; and
generating, by a generation unit, an external port number newly assigned to the internal address and the internal port number of the destination, in a case where the transmission source mapping algorithm is more complicated than the destination mapping algorithm.
